(19) United States
(12) Patent Application Publication
(10) Pub. No.: US 2026/0346931 A1
(43) Pub. Date: Nov. 5, 2026

(54) ADJUSTABLE SNOWMOBILE FRONT TRACK HEIGHT

(71) Applicant: Polaris Industries Inc., Medina, MN (US)

(72) Inventors: Michael A. HEDLUND, Roseau, MN (US); Jesse LAUGEN, Roseau, MN (US); Anthony RIPLEY, Ham Lake, MN (US); Ruben D. DOMINGUEZ, Rancho Cucamonga, CA (US); Randall ANDERSON, Riverside, CA (US); Andrew FJERSTAD, Princeton, MN (US); Alec LARSON, Columbus, MN (US); Eric FUCHS, Wyoming, MN (US); Joseph P. WOOD, Forest Lake, MN (US); Brian MacLEAN, Jurupa Valley, CA (US); Jeff JOHNSON, Warroad, MN (US); Joshua MICKELSON, Roseau, MN (US); Matthew PRUSAK, Salol, MN (US); Austin Allen LINDER, Roseau, MN (US); Jeremy Allen HUGHES, Roseau, MN (US); Kevin NESS, Osceola, WI (US)

(21) Appl. No.: 19/662,157

(22) Filed: Apr. 29, 2026

Related U.S. Application Data
(60) Provisional application No. 63/797,385, filed on Apr. 30, 2025.

(51) Int. Cl. B62D 55/116; B62D 55/06; B62D 55/112

(52) U.S. Cl. CPC B62D 55/116; B62D 55/06; B62D 55/112

(57) ABSTRACT

Hydraulic or mechanical controls are provided to control an effective length of a limiter strap or a shock absorber connected to the front torque arm. The hydraulic or mechanical controls can be controlled electronically in response to user selections or automatically. The controls can include a hydraulic cylinder configured to actuate a limiter strap attachment or to hydraulically control shock length. The control of shock length can be outside a shock spring. Hydraulic control of shock length can be controlled by hand, an actuator, or through self-pumping. Self-pumping can be facilitated by a push-pull valve. A cam can be used at the attachment of the shock to the front torque arm, allowing a position of the shock attachment relative to the front torque arm to be shifted by rotation of the cam so as to change an effective length of a connected shock.

### CROSS-REFERENCE TO RELATED APPLICATIONS

The present application claims priority from U.S. Provisional Patent Application Ser. No. 63/797,385, filed Apr. 30, 2025, the complete disclosure of which expressly incorporated by reference herein.

### BACKGROUND

Snowmobiles typically include a suspension system for a track assembly, with the suspension system including a front torque arm connected to the chassis of the snowmobile and also to rails of the track assembly. The suspension system can include a shock and a limiter strap to regulate the position of the front torque arm and the rails with respect to one another. Limiter straps have fixed lengths and attachment areas on the front torque arm and the rails. The fixed length of the limiter straps can be selected based on the desired handling characteristics of a user.

### SUMMARY

The present disclosure is directed to adjustable shocks or limiter straps for snowmobile front torque arms, and snowmobiles containing the front torque arms and adjustable shocks or limiter straps.

By controlling the effective length of a limiter strap or the shock absorber itself for the front torque arm, the ride characteristics can be customized by the rider during a ride. The effective length of the limiter strap or shock absorber can be controlled without requiring disassembly, and can be modified according to user input during a ride. This can allow suitable ride characteristics to be selected for changes in conditions such as snow depth or characteristics, terrain being traversed, and to account for individual rider preferences, for example when changing riders. Controlling shock length can optionally allow the limiter strap to be omitted, reducing the number of parts and potential points of failure. Allowing the shock length to be controlled can allow one set of parts to provide customizable ride characteristics for riders, without requiring multiple different parts or product lines directed to specific ride characteristics.

In an embodiment, a snowmobile includes a suspension system including a lower rail assembly and a front torque arm including a cross shaft and one or more links rotatably attached to the lower rail assembly. The snowmobile further includes a control interface configured to receive an operating mode provide an electronic control signal and an actuator configured to receive the electronic control signal and control a maximum height of the cross shaft relative to the lower rail assembly in response to the electronic control signal.

In an embodiment, a method of controlling snowmobile ride characteristics includes receiving, at a control interface, an operating mode for a snowmobile and transmitting an electronic control signal from the control interface to an actuator in response to receiving the operating mode. The method further includes receiving, at an actuator, the electronic control signal and operating the actuator in response to the electronic control signal. Operating the actuator changes a maximum height of a cross shaft of a front torque arm of a suspension system above a lower rail assembly of the suspension system.

In an embodiment, a snowmobile suspension system includes a lower rail assembly and a front torque arm. The front torque arm includes a cross shaft and one or more links rotatably attached to the lower rail assembly. The snowmobile suspension system further includes a shock absorber coupled to the cross shaft and the lower rail assembly, a limiter strap adjuster, and a limiter strap coupled to the limiter strap adjuster and the lower rail assembly. The limiter strap adjuster is configured to extend or retract the limiter strap so as to modify a length of the limiter strap extending from the cross shaft to the lower rail assembly.

In an embodiment, a snowmobile suspension system includes a front torque arm. The front torque arm includes a first link, a second link, a cross shaft extending between the first link and the second link, and a shock absorber mounting adjustment assembly provided on the cross shaft, the shock absorber mounting assembly including one or more cam supports configured to receive a fastener, a cam including a cam body defining a shock mounting surface and an aperture configured to receive the fastener such that the cam can rotate about the fastener. A center of the cam body defining the shock mounting surface is offset from a center of the aperture. The snowmobile suspension system further includes an actuator configured to rotate the cam about the fastener.

A snowmobile suspension system including a lower rail assembly and a front torque arm. The front torque arm includes a cross shaft and a plurality of links coupled to the cross shaft. Each of the plurality of links is rotatably coupled to the lower rail assembly. The snowmobile suspension system further includes an adjustable shock absorber coupled to the cross shaft of the front torque arm and coupled to the lower rail assembly. The adjustable shock absorber includes an adjustable segment disposed at an end of the adjustable shock absorber. The adjustable segment defining an adjustment volume. The adjustable shock absorber further includes a piston configured to travel along the adjustment volume to as to increase or decrease an effective length of the adjustable shock absorber, a reservoir in fluid communication with the adjustment volume, and an actuator configured to move fluid from the reservoir to the adjustment volume or from the adjustment volume to the reservoir.

In an embodiment, a snowmobile suspension system includes a lower rail assembly and a front torque arm. The front torque arm includes a cross shaft and a plurality of links coupled to the cross shaft. Each of the plurality of links is rotatably coupled to the lower rail assembly. The snowmobile suspension system further includes an adjustable shock absorber coupled to the cross shaft of the front torque arm and coupled to the lower rail assembly. The adjustable shock absorber includes a cylinder, a shaft including a piston head provided within the cylinder an internal piston provided in a first space on a first side of the piston head within the cylinder, and a valve assembly configured to control flow of fluid from the first side to a second space on a second side of the piston head within the cylinder. The valve assembly is configured to allow flow from the second space to the first space and obstruct flow from the first space to the second space in a first mode, and the valve assembly is configured to allow flow from the first space to the second space in a second mode.

In an embodiment, an adjustable end cap for a shock absorber includes an attachment body. The attachment body defines an internal space. The adjustable end cap further includes a piston disposed in the internal space. The piston includes a shock absorber shaft receptacle configured to receive a shaft of a shock absorber. The piston is movable within the internal space such that a distance from the shock absorber shaft receptacle to an opposite end of the attachment body can be modified. The adjustable end cap also includes a fluid control configured to distribute fluid between a first space and a second space so as to control a position of the piston within the internal space.

### BRIEF DESCRIPTION OF THE DRAWINGS

FIG. 1 shows an upper front perspective view of an example snowmobile.

FIG. 2 shows a side view of an example endless belt assembly for a snowmobile.

FIG. 3 shows a schematic view of an example snowmobile.

FIG. 4 shows a schematic of an example control system for snowmobile ride characteristics.

FIG. 5 shows a flowchart of an example method for controlling snowmobile ride characteristics.

FIG. 6 shows a side view of an example snowmobile suspension system including an adjustable limiter strap.

FIG. 7 shows a top view of the example snowmobile suspension system of FIG. 6.

FIG. 8 shows an elevated front perspective view of the example snowmobile suspension system of FIG. 6.

FIG. 9 shows an example limiter strap actuator.

FIG. 10 shows a perspective view of an example front torque arm having a cam-adjustable shock attachment.

FIG. 11 shows a perspective view of an example adjustment cam.

FIG. 12 shows an example snowmobile suspension system including the example front torque arm of FIG. 10.

FIG. 13 shows an example snowmobile suspension system including an adjustable front track shock.

FIG. 14A shows a sectional view of an adjustable front track shock according to an embodiment.

FIG. 14B shows the adjustable front track shock of FIG. 14A for its full length.

FIG. 15 shows a second sectional view of the adjustable front track shock of FIG. 14A.

FIG. 16 shows a side view of an example snowmobile suspension system including an adjustable front track shock.

FIG. 17 shows a rear view of the example adjustable front track shock of FIG. 16.

FIG. 18 shows an exploded view of the example adjustable front track shock of FIG. 16.

FIG. 19 shows a sectional view of an example adjustable shock absorber.

FIG. 20A shows an example push-pull valve of the adjustable shock absorber of FIG. 19 in a first position.

FIG. 20B shows the push-pull valve of FIG. 20A in a second position.

FIG. 21 shows a sectional view of an example adjustable shock absorber.

FIG. 22A shows an example shock absorber length adjuster in a first position.

FIG. 22B shows the example shock absorber length adjuster of FIG. 22A in a second position.

FIG. 23A shows an example shock absorber length adjuster in a first position.

FIG. 23B shows the example shock absorber length adjuster of FIG. 23A in a second position.

FIG. 24 shows an example handlebar-mounted control.

### DETAILED DESCRIPTION

The present disclosure is directed to adjustable shocks or limiter straps for snowmobile front torque arms, and snowmobiles containing the front torque arms and adjustable shocks or limiter straps.

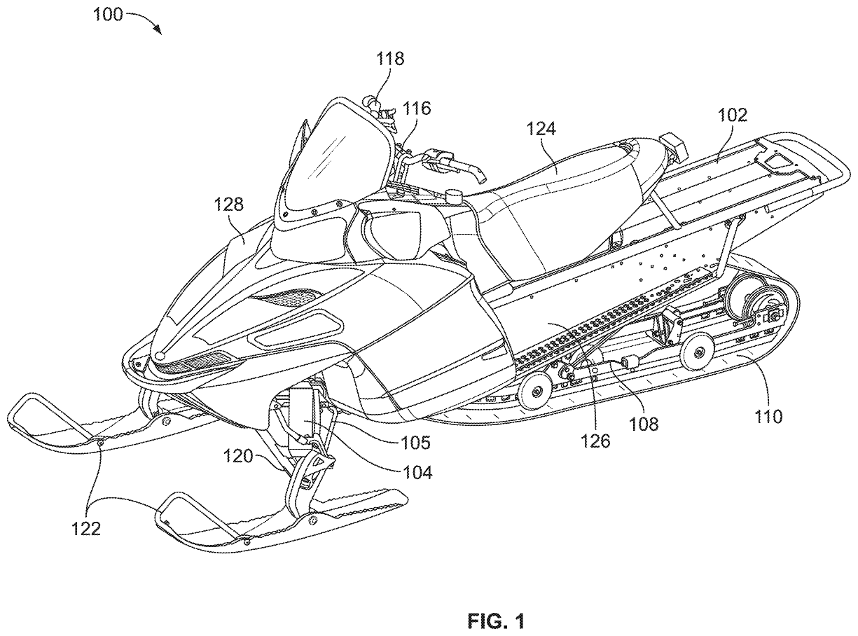

FIG. 1 shows an example snowmobile 100 having a base construction into which structural aspects of the present disclosure can be incorporated. The snowmobile 100 includes a chassis 102. A front suspension 104 supports the chassis relative to front skis 106 and a rear suspension 108 supports the chassis relative to a track 110. The front suspension 104 can include control arms 105 and shock absorbing/damping structures. The rear suspension 112 can also include shock absorbing/damping structures. A powertrain is supported by the chassis 102. The powertrain drives rotation of the track 110 to provide propulsion of the snowmobile 100. The snowmobile includes a steering system 114 for allowing an operator to steer the snowmobile 100. The steering system 114 can include a steering shaft 116 and a handlebar 118 that is manually turned to rotate the steering shaft 116. Steering links 120 are operatively coupled to the steering shaft 116 and to knuckles corresponding to the skis 122 such that the skis 122 are turned in response to rotation of the steering shaft 116 by the handlebar 118. A seat 124 is supported on the chassis behind the handlebar 118 and running board assemblies 126 are coupled to the chassis on opposite sides of the seat 124. An outer shell/body 128 can at least partially cover the chassis, powertrain, and other components.

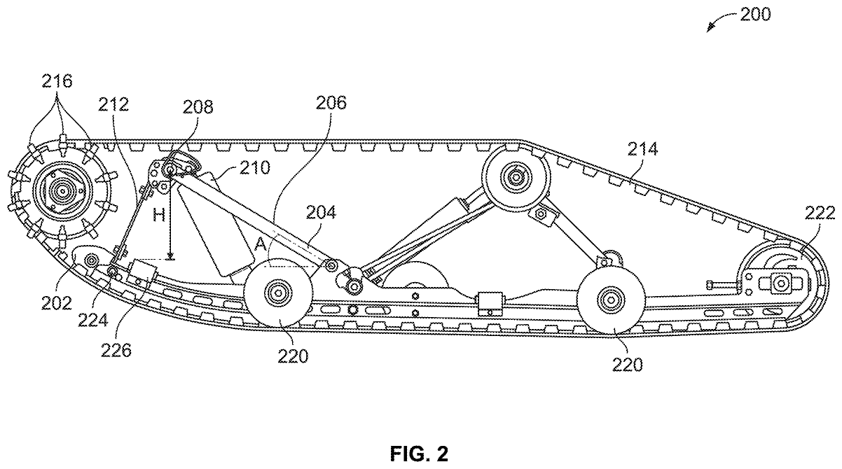

FIG. 2 shows an example endless belt assembly for a snowmobile. Endless belt assembly 200 includes lower rails 202, front torque arm 204 including links 206 and cross shaft 208, and shock absorber 210 coupled to the lower rails 202 and the cross shaft 208 of front torque arm 206. A limiter strap 212 can optionally be included. Endless belt assembly 200 can provide the track 110 as discussed above and shown in FIG. 1, and features supporting the track such as lower rails 202 and the suspension including front torque arm 204, shock absorber 210, and optional limiter strap 212.

Lower rails 202 are configured to support and guide the endless belt 216. Front torque arm 204 includes links 206 and cross shaft 210. Links 206 can be rotatably coupled to the lower rails 202, for example at front cross shaft 224. A height of cross shaft 208 above the lower rails 202 can change as links 206 rotate. The height H can be defined as the height from bumpers 226 provided on the lower rails 202 to the cross shaft 208 when shock absorber 210 is in a resting, fully extended, or uncompressed position. Height H can be a maximum height of the cross shaft 208 relative to lower rails 202 as permitted by a limiter strap 212 or a fully extended length of shock absorber 210. The height H can be a function of the length of links 206 and an angle A defined between the extending direction of the links 206 and a line parallel to the ground. The angle A and thus height H can be modified by adjusting an effective length of shock absorber 210 from an attachment point coupled to the cross shaft 208 to an attachment point coupled to lower rails 202. The cross shaft 208 can couple the links 206 together. Cross shaft 208 can be coupled to the chassis of the snowmobile. Shock absorber 210 can be coupled to cross shaft 208 and lower rails 202. Shock absorber 210 is configured to regulate the distance between cross shaft 208 and lower rails 202.

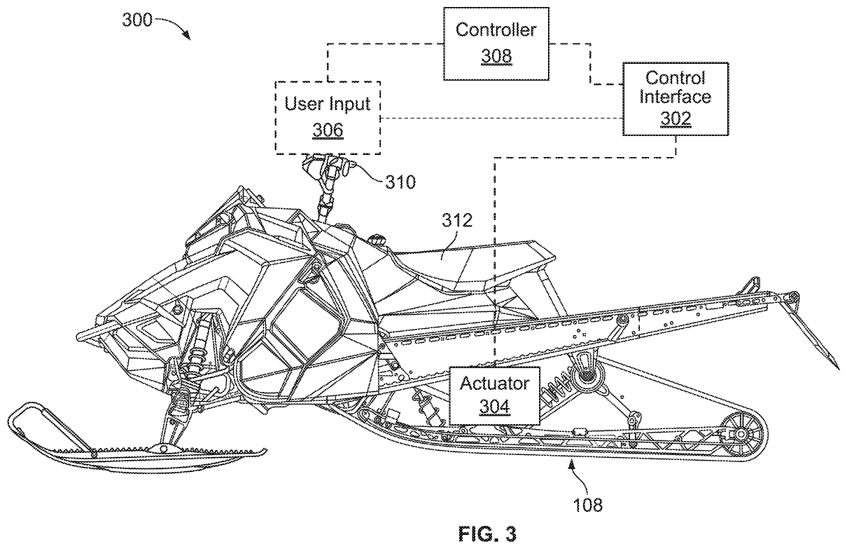

In some embodiments, limiter strap 212 can be provided. Limiter strap 212 can be secured to lower rails 202 and the front torque arm 204. In an embodiment, limiter strap 212 is coupled to front torque arm 204 at cross shaft 208. In an embodiment, limiter strap 212 can instead be coupled to a movable attachment point, for example as shown in FIGS. 3-6 and described below. Limiter strap 212 can provide a tensile limiter controlling a maximum distance for lower rails 202 relative to cross shaft 208. In some embodiments, limiter strap 212 can be omitted from the endless belt assembly 200. In such embodiments, the shock absorber 210 can be the only member regulating the distance between cross shaft 208 and lower rails 202. The distance between cross shaft 208 and lower rails 202 can control the weight distribution of a snowmobile, allowing the weight to be primarily borne by lower rails 202, or distributing the weight more evenly among the front skis and the entire length of the portion of endless belt assembly 200 contacting the ground. The change in weight distribution can affect the handling characteristics of the snowmobile including acceleration, turning, inclination to change pitch, and the like.

Endless belt assembly 200 can further include endless belt 214 configured to be engaged by sprockets 216 to transfer power from a motor driving shaft 218 to the belt. The endless belt assembly 200 can also include a plurality of wheels 220 and idler pulleys 222 to support and guide endless belt 214.

FIG. 3 shows a schematic view of an example snowmobile. Example snowmobile 300 includes control interface 302 and actuator 304. Snowmobile 300 can further include a user input 306. Snowmobile 300 can include a controller 308.

Control interface 302 is configured to receive an operating mode for the snowmobile 300 and output an electronic control signal in response to the received operating mode. The operating mode can be, for example, a command to shorten or lengthen the height from the lower rail assembly to the front torque arm, a specific height to achieve, a selection of a height setting from a plurality of predetermined height settings, or the like. In an embodiment, the plurality of predetermined height settings includes at least three height settings. In an embodiment, the plurality of predetermined height settings includes at least four height settings. In an embodiment, the plurality of predetermined height settings includes at least five height settings. The height settings can each be associated with particular ride characteristics, such as aggressiveness of handling or acceleration, smoothness of ride, tendency to pitch, precision of handling or acceleration, and the like. The height settings can be named or classified according to the ride characteristics associated therewith, such as “aggressive” or “precision” modes. In an embodiment, the operating mode can be received from a rider interacting with user input 306, such as flipping a switch or moving a toggle to select the operating mode, pressing a button to issue the command to shorten or lengthen the height, turning a dial to a specific height, or the like. In an embodiment, the operating mode can be received at control interface 302 from a controller 308 configured to determine the operating mode, for example based on input from user input 306 or input from one or more sensors included in snowmobile 300.

When the operating mode is received, control interface 302 can provide an electronic control signal suitable to direct actuator 304 to perform according to the operating mode. The electronic control signal can be a signal such as a voltage signal, a supply of current, or the like. In an embodiment, the electronic control signal can be sufficient to operate the actuator 304, for example being a supply of current suitable to operate a motor, open a solenoid valve, or the like. In an embodiment, the electronic control signal can be signal suitable for being received at a controller included in the actuator 304, directing the controller of actuator 304 to operate the actuator 304.

Actuator 304 is an actuator capable of a maximum height from a lower rail assembly such as lower rails 202 described above and shown in FIG. 2 to a front torque arm cross shaft, such as cross shaft 208 described above and shown in FIG. 2 thereof. Actuator 304 can include or be included in a limiter strap adjuster, a shock absorber mounting adjustment assembly, an adjustable shock absorber, or an adjustable end cap for a shock absorber as described further below. Examples of actuator 304 can include motors such as servo or stepper motors, valve assemblies including electrically operable valves such as solenoid valves, valve assemblies operable by motors such as servo or stepper motors, or the like. In an embodiment, actuator 304 can be directly operated by the electronic control signal, for example where the electronic control signal is a supply of current to an electric motor or a solenoid valve. In an embodiment, actuator 304 can include a controller operating the actuator 304 in response to the electronic control signal.

User input 306 is a device receiving user input indicative of an operating mode for the snowmobile 300. For example, user input 306 can receive input of a command to shorten or lengthen the height from the lower rail assembly to the front torque arm, a specific height to achieve, a selection of a height setting from a plurality of predetermined height settings, or the like provided by a user. In an embodiment, user input 306 can be a manually operated selector, such as one or more buttons, toggles, switches, dials, or the like. In an embodiment, user input 306 can be a touch screen. In an embodiment, user input 306 can include or be provided in a user interface presented on a display. In an embodiment, the display is a touch screen. In an embodiment, the display is a display of a control system for shock absorber damping characteristics, such as a suspension control module, for example as described in U.S. Patent Application Pub. No. 2021/0362806, titled “SYSTEMS AND METHODS OF ADJUSTABLE SUSPENSIONS FOR OFF-ROAD RECREATIONAL VEHICLES” which is herein incorporated by reference in its entirety. In an embodiment, user input 306 can communicate received input to controller 308. In an embodiment, user input 306 can communicate received input to the control interface 302. In such an embodiment, the input provided at user input 306 can trigger control interface 302 to provide the electronic control signal to actuator 304.

User input 306 can be provided on snowmobile 300 in a position where the user input 306 can be accessed by a rider during operation of the snowmobile 300. For example, user input 306 can be provided on handlebars or a center column of steering assembly 310, on or near part of seat 312, as part of a dashboard or other control panel provided on snowmobile 300, or the like.

Controller 308 can be configured to determine the operating mode and provide the operating mode to control interface 302. The controller 308 can determine the operating mode based on one or more user inputs including user input, acceleration of the snowmobile, pitch of the snowmobile, power output of an engine of the snowmobile, position of one or more shock absorbers of the snowmobile, input at a brake of the snowmobile, and input at a throttle of the snowmobile. In an embodiment, one or more of the inputs to controller 308 can be determined using one or more sensors incorporated into the controller 308. In an embodiment, the controller 308 can include processors and memories configured to determine the operating mode based on the input, for example using suitable algorithms, data such as thresholds or lookup tables, and the like. In an embodiment, the controller 308 can be a controller of a control system for shock absorber damping characteristics, such as a suspension control module, further configured to determine the operating mode of the snowmobile 300 as discussed herein.

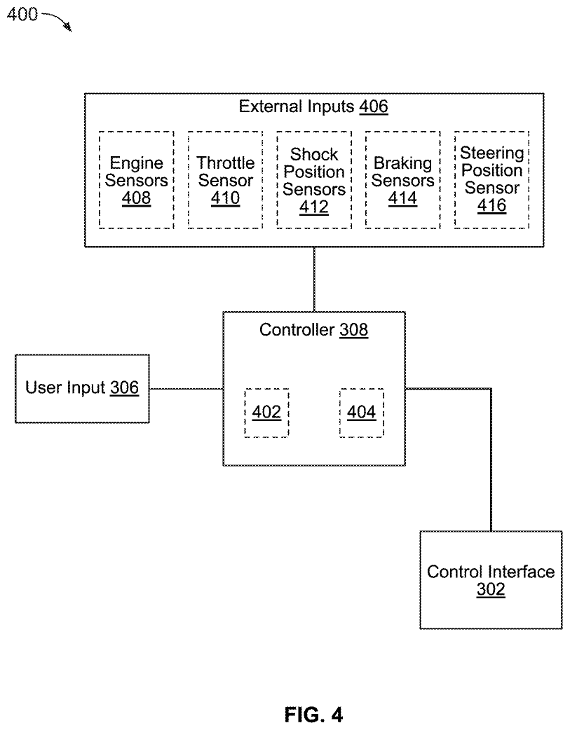

FIG. 4 shows a schematic of an example control system for snowmobile ride characteristics. Control system 400 includes the control interface 302, user input 306, and controller 308 as discussed above, with user input 306 connected to the controller 308. In control system 400, the controller 308 includes accelerometer 402 and inertial measurement unit (IMU) 404. The controller 308 is connected to external inputs 406.

Accelerometer 402 can be provided in controller 308. The accelerometer can provide acceleration data for the snowmobile such as longitudinal or lateral acceleration thereof. Data from accelerometer 402 can be used, for example to detect acceleration or braking events, determine cornering, determine when many turns are made in succession, and the like. IMU 404 can further be included in controller 308. IMU 404 can include a gyroscope. IMU 404 can provide controller 308 with data regarding the orientation of the snowmobile and changes thereto, such as the pitch of the snowmobile and changes in pitch over time, for example during acute events such as a wheelie, regular events such as traveling over moguls, or the like.

External inputs 406 can furnish data regarding the operation of and controls issued to the snowmobile. The external inputs can include an engine sensor 408, a throttle sensor 410, a shock absorber position sensor 412, a braking sensors 414, and a steering position sensor 416. Engine sensors 408 can be one or more sensors included in or coupled to the engine and detecting properties thereof, such as an engine speed or power output. Throttle sensor 410 can be a sensor provided at a throttle actuator, engine, or between the actuator and the engine and capable of detecting a throttle position of the snowmobile. Shock absorber position sensors 412 can be one or more sensors provided on shock absorbers included in the snowmobile, such as front ski shock absorbers or track shock absorbers such as front or rear track shock absorbers. The shock absorber position sensors 412 can provide current positions of the respective shock absorbers such as the compression or extension thereof. The braking sensors 414 can include one or more sensors provided on a brake control, at the brakes themselves, or between the brake control and the brakes so as to detect operation of the brakes by a user or their action to stop the snowmobile. Steering position sensor 416 can be a sensor provided in a steering assembly of the snowmobile, for example on the steering column, so as to provide feedback regarding the position and operations of the steering assembly such as an extent of turning of the handlebars, frequency of such turning or changes thereto, and the like. The external inputs can provide data usable by controller 308 to determine the operating mode for the snowmobile, automatically or further based on input received at user input 306.

In control system 400, user input 306 can provide input from a user to the controller 308. In some examples, the input provided at user input 306 can be a direct selection of the operating mode to be output by the controller 308 to the control interface 302. In some examples, the input provided at user input 306 can contribute to a determination of an operating mode by the controller 308. For example, user input 306 can allow input of desired ride characteristics, expected conditions or type of ride, or the like. In an embodiment, user input 306 can allow for selection of a mode of use for the snowmobile, such as use of the snowmobile to tow a sled or other vehicle. User input 306 can, for example, include a user interface provided on a display and one or more inputs such as a touch screen, buttons, switches, dials, a keypad, or the like. User input 306 can be a user input for a control system for shock absorber damping characteristics, such as a suspension control module of the snowmobile.

In control system 400, controller 308 can be configured to detect one or more events or conditions and output an operating mode associated with the detected events or conditions. The conditions can be detected based on data from one or more of accelerometer 402, IMU 404, external inputs 406, and user input 306. In an embodiment, one or more predictions can be made based on data, and the predictions can be used in determining events or conditions. For example, longitudinal acceleration can be predicted based on throttle or engine data, lateral acceleration can be predicted based on speed and steering position, pitch can be predicted based on actual or predicted acceleration, or the like. The events or conditions can be detected through any suitable processing of the data, for example using threshold values for one or more parameters of the data or predictions based thereon, comparison of one or more parameters of the data or predicted values to lookup tables, algorithms for determining events or conditions based on the data or predicted values, or the like. Examples of events or conditions that can be detected at controller 308 can include cornering, large pitch, significant changes to pitch, braking, acceleration, the snowmobile going airborne, trail riding, fresh snow riding, climbing hills, or the like. Events or conditions can be associated with particular operating modes to output from controller 308 to control interface 302. For example, trail riding may be associated with a first height setting, fresh snow riding may be associated with a second height setting, and hill climbing can be associated with a third height setting for the height from the lower rail assembly to the front torque arm. In another example, conditions such as going airborne or experiencing large changes in pitch can be associated with changing the height from the lower rail assembly to the front torque arm. In an embodiment, a combination of conditions and input from user input 306 can be used to determine the operating mode to be output to control interface 302. For example, a user can input a preference for or desire to avoid large changes in pitch. The preference can affect the response to changes in pitch, for example allowing more aggressive riding for fun or reduction of tendency to change pitch when a rider prefers a smoother ride. In an embodiment, a threshold number of events or a threshold frequency of such events can be used to determine the operating mode to be output to control interface 302, for example not adjusting for changes in pitch until multiple such changes, indicative of, for example, rough trail conditions overall are detected.

In control system 400, controller 308 is configured to output the determined operating mode to control interface 302 so as to cause the generation of the electronic control signal output by control interface 302.

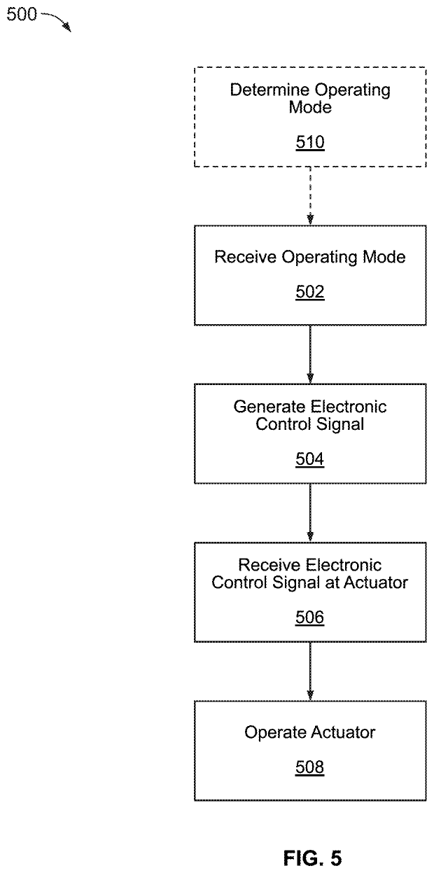

FIG. 5 shows a flowchart of an example method for controlling snowmobile ride characteristics. Method 500 includes receiving an operating mode at step 502, generating an electronic control signal at step 504, receiving the electronic control signal at an actuator at step 506, and operating the actuator at step 508. Optionally, method 500 can include determining the operating mode at step 510.

The operating mode is received at step 502. The operating mode can be a selection of a maximum height from a lower rail assembly of a snowmobile to a front torque arm cross shaft thereof. The operating mode can be received as a command to shorten or lengthen the height from the lower rail assembly to the front torque arm, a specific height to achieve, a selection of a height setting from a plurality of predetermined height settings, or the like. In an embodiment, at step 502, the operating mode can be received from a selector, such as one or more buttons, toggles, switches, dials, or the like. In an embodiment, the selector is positioned so as to be accessible by a rider sitting in a seat of the snowmobile, for example the selector being disposed on handlebars of the snowmobile. In an embodiment, the operating mode can be received at step 502 from a controller. In an embodiment, the operating mode received at step 502 from the controller is a manual input of operating mode provided to the controller. In an embodiment, the operating moder received at step 502 from the controller is determined by the controller, for example at optional step 510. The operating mode can be received at step 502 at a control interface.

Optionally, the operating mode received at step 502 can be determined automatically, for example at the controller. The determination of the operating mode at 510 can be based on inputs from one or more inputs such as, for example, acceleration of the snowmobile, pitch of the snowmobile, power output of an engine of the snowmobile, position of one or more shock absorbers of the snowmobile, input at a brake of the snowmobile, and input at a throttle of the snowmobile. The inputs can include inputs received from suitable sensors or systems of the snowmobile, such as shock absorber position sensors, brake pressure sensors, an engine speed sensor, a vehicle speed sensor, a break switch, a steering angle sensor, throttle sensors, global positioning system (GPS) signals or position inputs, or the like. The inputs can include inputs received from one or more sensors included in or integrated with the controller, such as an accelerometer, an IMU, a gyroscope, or the like. The inputs can be used to determine an event, such as, for example, cornering, large pitch, significant changes to pitch, braking, acceleration, the snowmobile going airborne, or the like using suitable criteria such as an algorithm, a lookup table, or the like. In an embodiment, the inputs can be used to determine the environment, conditions, or type of ride the snowmobile is being used for, such as trail riding, fresh snow riding, climbing hills, or the like, based on suitable criteria, for example for averages over time of one or more of the inputs. In an embodiment, an input can include a user selection of a mode such as a towing mode, or a type of ride such as trail riding, fresh snow riding, climbing hills, or the like. The user selection can be used to determine to shorten or lengthen the height from the lower rail assembly to the front torque arm, determine a specific height to achieve, determine a selection of a height setting from a plurality of predetermined height settings, or the like. The operating mode determined at optional step 510 can be received by the control interface at 502.

In response to receiving the operating mode at step 502, an electronic control signal is generated at step 504. The electronic control signal can be any suitable electronic signal for triggering activation of an actuator, such as a voltage signal. In an embodiment, the electronic control signal is a supply of current sufficient to operate the actuator, for example operating a servo or stepper motor, triggering opening of a solenoid valve such as a solenoid check valve, or the like. In an embodiment, the electronic control signal can be detected by a controller of the actuator, which in turn triggers operation of the actuator. The electronic control signal can be generated at step 504 at a control interface receiving the operating mode at step 502.

The electronic control signal is received at the actuator at step 506. The actuator can be any actuator capable of controlling the maximum height from the lower rail assembly to the front torque arm, for example a servo or stepper motor, an electronically controllable valve assembly such as a valve assembly including one or more solenoid valves, or the like. The actuator can be included in a limiter strap adjuster, a shock absorber mounting adjustment assembly, an adjustable shock absorber, or an adjustable end cap for a shock absorber as described further below. The electronic control signal can be received at step 506 by way of a wired connection between the control interface and the actuator.

In response to receipt of the electronic control signal at step 506, the actuator can be operated at step 508. Operation of the actuator at step 508 can include, for example, opening one or more solenoid valves, adjusting a position of a movable valve or element thereof such as a rotating portion of a valve, linear movement of a push-pull valve, or the like. Operation of the actuator at step 508 can include operation of one or more motors such as servo or stepper motors. Operation of the actuator at step 508 can modify a maximum height from a lower rail assembly of a snowmobile to a front torque arm cross shaft thereof, for example by operating a limiter strap adjuster, a shock absorber mounting adjustment assembly, an adjustable shock absorber, or an adjustable end cap for a shock absorber as described further below. The change to the maximum height from the lower rail assembly to the front torque arm can change weight distribution and handling characteristics of the snowmobile, for example tendency to pitch, acceleration, turning, and other such characteristics.

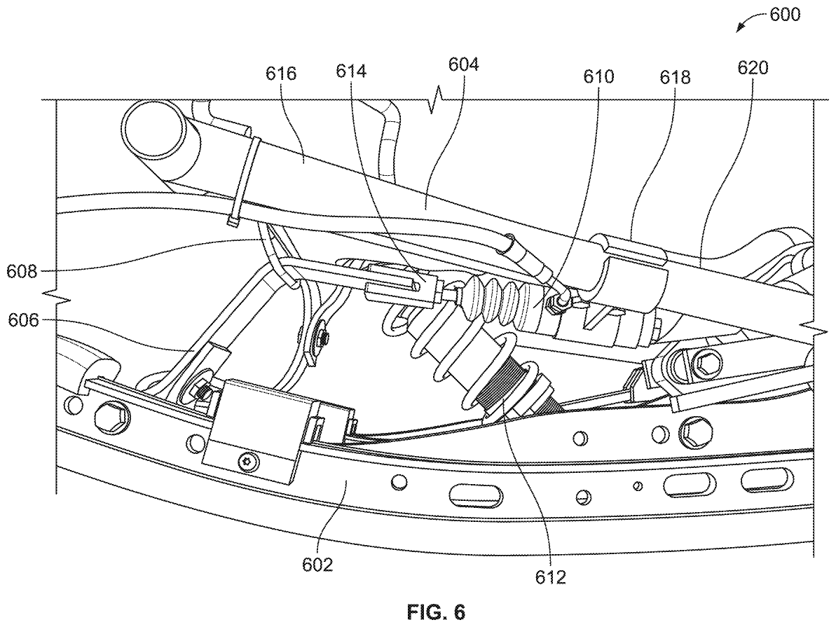

FIGS. 6-8 show an example snowmobile suspension system including an adjustable limiter strap. Snowmobile suspension system 600 includes lower rails 602, front torque arm 604, limiter strap 606, limiter strap loop 608, limiter strap actuator 610, and shock absorber 612.

Lower rails 602 can include an attachment for the limiter strap 606, for example a cross shaft included in the lower rails 602. Limiter strap 606 can have a fixed coupling to the lower rails 302. Limiter strap loop 308 can guide and retain limiter strap 606. Limiter strap loop 608 and front torque arm 604 can define a complete perimeter surrounding an aperture through which the limiter strap 606 passes. Limiter strap 606 can bend around a portion of limiter strap loop 608 or front torque arm 604. An end of limiter strap 606 opposite the end attached to lower rails 602 can be coupled to limiter strap actuator 610 at an attachment point 614, for example by a bolt passing through a clip coupled to the limiter strap actuator 610 and a corresponding through hole provided in the limiter strap 606.

The limiter strap actuator 610 is configured to move the limiter strap 606 such that an effective length of the limiter strap 606 from limiter strap loop 608 or front torque arm 604 to the lower rails 602. In an embodiment, the limiter strap actuator 610 can be configured to move an attachment point 614 for the limiter strap 606, such as a clip, in a linear direction. The linear direction can have at least a component parallel to an extension direction of the links 616 of the front torque arm 604. In alternative embodiments, limiter strap actuator 610 can be rotated to wind a portion of the limiter strap 606 or otherwise adjust the effective length of the limiter strap 606. In an embodiment, the limiter strap actuator 610 is a hydraulic actuator. Where limiter strap actuator 610 is a hydraulic actuator, a reservoir can be provided to store at least some hydraulic fluid used by limiter strap actuator 610. In an embodiment, limiter strap actuator 610 can be manually controlled, for example through a manually rotatable knob. In an embodiment, limiter strap actuator 610 can be electronically controlled, for example by way of a servo motor or the like. In an embodiment, limiter strap actuator 610 can move between at least a first position having a first effective length for the limiter strap 606 and a second position having a second effective length for the limiter strap 606. In an embodiment, the limiter strap actuator can allow for continuous variation of the effective length of the limiter strap 606 over a range from a maximum effective length to a minimum effective length. In an embodiment, the difference between the maximum effective length and the minimum effective length can be such that the maximum extent of variation in height from lower rails 602 to a cross shaft 622 of the front torque arm 604 is in a range from approximately one half of an inch to approximately one and one quarter inches. Limiter strap actuator 610 can be coupled to the front torque arm 604, for example by way of a clamp 618 and a bracket 620 attached to one of the links 616.

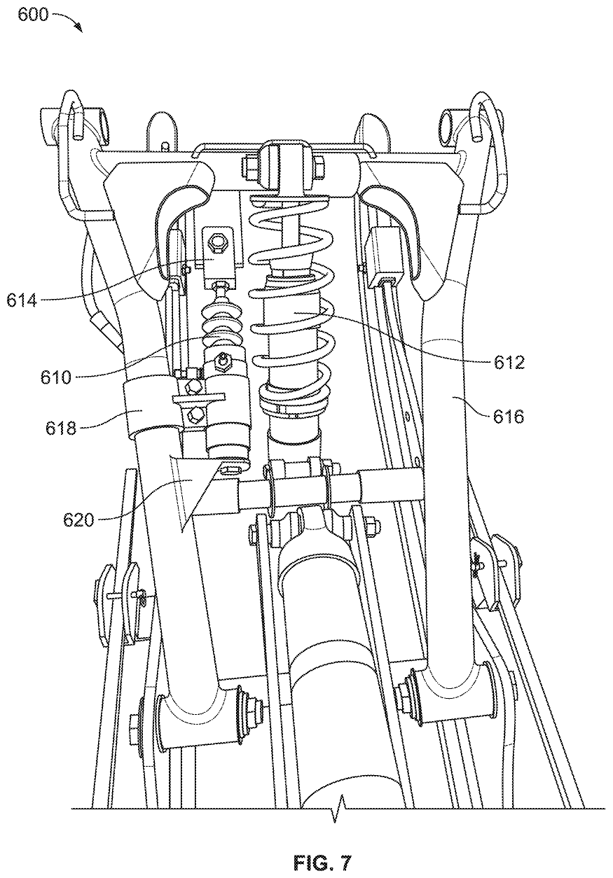

Referring to the top view of FIG. 7, clamp 618 and a bracket 620 can be seen coupling the limiter strap actuator 610 to one of the links 616. The coupling of the limiter strap actuator 610 to link 616 can prevent movement of the body of limiter strap actuator 610 in the linear direction in which attachment point 614 moves to adjust the effective length of the limiter strap 606. The limiter strap actuator 610 and limiter strap 606 are biased towards one of the links 616 such that there is no interference with shock absorber 612.

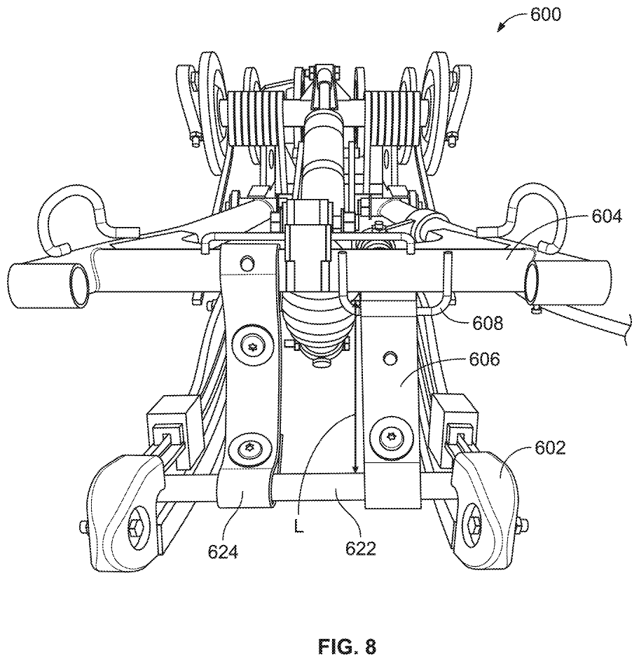

Referring to the upper front perspective view of FIG. 8, the opening defined between front torque arm 604 and limiter strap loop 608 can be seen. Limiter strap loop 608 can be a metal member formed with or coupled to the front torque arm 604, for example being welded to the front torque arm 604. The opening allows limiter strap 606 to pass therethrough. The effective length L of the limiter strap 606 is the distance the limiter strap 606 extends from the opening defined between front torque arm 604 and limiter strap loop 608 to the attachment of limiter strap 606 to the rails 602, for example at cross shaft 622, as can be seen in FIG. 8. The effective length L can be modified by extending or retracting the limiter strap actuator 610 so as to change the length of the portion limiter strap 606 extending from limiter strap loop 608 to the cross shaft 622. In an embodiment, a fixed length limiter strap 624 can optionally further be included, for example to provide redundancy, to support the adjustable limiter strap 606 at its maximum effective length, or the like. Fixed length limiter strap 624 can have a length corresponding to the largest effective length of the limiter strap 606.

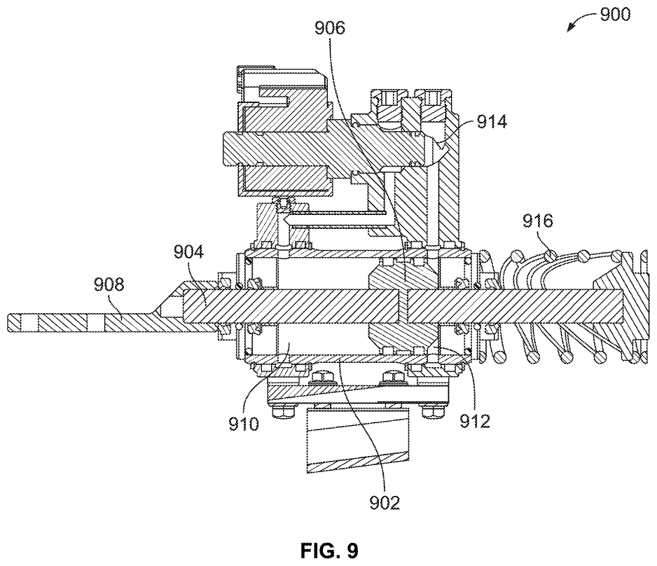

FIG. 9 shows an example limiter strap actuator. Limiter strap actuator 900 can be used in place of the limiter strap actuator 610 in snowmobile suspension system 600. The limiter strap actuator 900 includes cylinder 902 and piston 904 having head 906. Limiter strap attachment 908 is attached to piston 904. Within the cylinder 902, a first space 910 and a second space 912 are provided on opposite sides of the head 906 of piston 904. A valve assembly 914 can control flow of hydraulic fluid between the first and second spaces 910, 912. A spring 916 can be attached to piston 904.

Cylinder 902 contains hydraulic fluid. The position of piston 904 within cylinder 902 can be controlled based on hydraulic fluid in first space 910 and second space 912, which are respectively provided within cylinder 902 on opposing sides of head 906 of piston 904. The first space 910 and the second space 912 can change in size as hydraulic fluid is added or removed from the respective volume 910, 912. By changing the position of piston 904, the position of limiter strap attachment 908 can be extended or retracted, thereby modifying the effective length of an attached limiter strap such as limiter strap 606 of the snowmobile suspension system 600.

Valve assembly 914 can control flow of the hydraulic fluid from first space 910 to second space 912 and vice versa. Valve assembly 914 can be in communication with first and second spaces 910, 912 through respective first and second passages 918, 620. The valve assembly 914 can include one or more check valves. In a first position, valve assembly 914 can permit flow from the first space 910 to the second space 912, and prohibit flow from the second space 912 to the first space 910, thereby allowing hydraulic fluid to accumulate in second space 912 and driving piston 904 to extend the limiter strap when force is applied to the limiter strap. In a second position, valve assembly 914 can permit flow from the second space 912 to the first space 910, and can optionally prohibit flow from the first space 910 to the second space 912. In the second position, spring 916 can provide force on piston 904 to retract piston 904, driving hydraulic fluid from the second space 912 to the first space 910 through valve assembly 914. The movement of piston 904 due to spring 916 and the hydraulic fluid being moved to first space 910 can retract the limiter strap. The valve assembly 914 can be, for example, a solenoid check valve operating as a check valve in the first position and capable of being actuated to open as the second position.

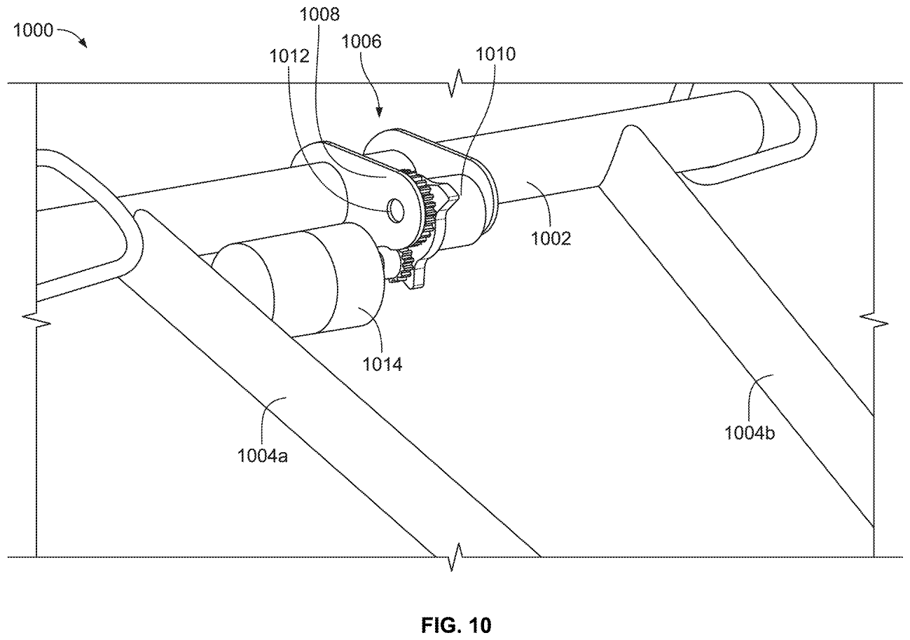

FIG. 10 shows an example front torque arm having a cam-adjustable shock attachment. Front torque arm 1000 includes shaft 1002, links 1004a and 1004b, and shock absorber mounting adjustment assembly 1006. Shock absorber mounting adjustment assembly 1006 includes cam supports 1008 and cam 1010. Cam supports 1008 and cam 1010 can define a fastener opening 1012. A cam actuator 1014 can be coupled to the front torque arm 1000.

Front torque arm 1000 can be a front torque arm of a snowmobile suspension system, for example front torque arm 204 of the endless belt assembly 200 as discussed above and shown in FIG. 2. The front torque arm 1000 includes shaft 1002 and links 1004a and 1004b. Shaft 1002 can be attached to a chassis of the snowmobile including front torque arm 1000.

Shock absorber mounting adjustment assembly 1006 can be provided along shaft 1002 between links 1004a and 1004b. Shock absorber mounting assembly 1006 is configured to allow attachment of a shock absorber, such as shock absorber 210 described above and shown in FIG. 2, to the front torque arm 1000. Shock absorber mounting adjustment assembly 1006 is configured such that the position of the shock absorber relative to front torque arm 1000 can be adjustable.

Cam supports 1008 are fixed to shaft 1002, for example being formed integrally, welded in place, or the like. Cam supports 1008 can be spaced apart such that cam 1010 can be received between the cam supports 1008. Cam 1010 can provide a mount for the shock absorber. Fastener opening 1012 can be defined by corresponding apertures in the cam supports 800 and cam 1010. The fastener opening 1012 can be configured to receive a pin, bolt, or other such linear fastener. The fastener provided in fastener opening 1012 can be selected such that cam 1010 can rotate about the fastener. Cam 1010 can be configured such that rotation of the cam 1010 about a fastener provided through fastener 1012 can change a mounting position of the shock absorber relative to the shaft 1002.

Cam actuator 1014 can be coupled to the front torque arm 1000, for example at shaft 1002. The cam actuator can be a suitable actuator for interfacing with cam 1010 to control rotation of the cam 1010 about a fastener provided through fastener opening 1012. For example, cam actuator 1014 can include a gear configured to interface with a corresponding gear provided on the cam 1010. Cam actuator 1014 can include a controllable motor or other suitable actuator capable of driving rotation of the cam 1010. Cam actuator 1014 can be controlled through any suitable control, such as a mechanical or electronic control. The control of cam actuator 1014 can be provided at, for example, at handlebar 118 such that the cam actuator 1014 can be controlled by a rider during operation of a snowmobile.

Movement of the shock absorber attachment relative to the front torque arm 1000 can alter the effective length of the shock absorber, thus controlling a distance from the shaft 1002 to lower rails of the snowmobile. The control of the effective length of the shock absorber can provide control over the ride properties of the snowmobile, such as the aggressiveness or precision of response of the snowmobile to acceleration. In an embodiment, the movement of the shock absorber attachment on cam 1010 can be between two discrete settings providing a first effective length and a second effective length to the shock. In an embodiment, additional discrete settings or continuous variation between a minimum and a maximum effective length can be provided.

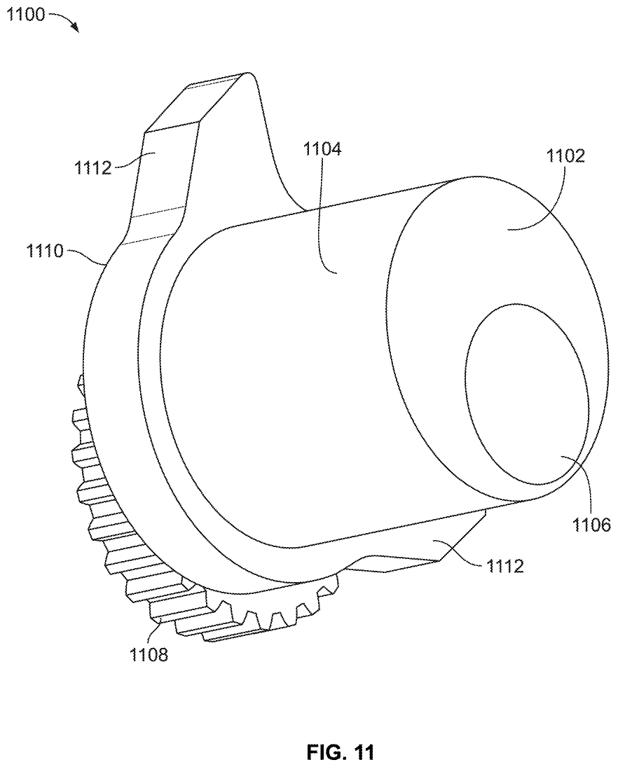

FIG. 11 shows a perspective view of an example adjustment cam. Adjustment cam 1100 can be used as the cam 1010 in front torque arm 1000 as shown in FIG. 10 and described above. Adjustment cam 1100 includes cam body 1102 having a shock absorber mounting surface 1104 and an attachment aperture 1106. Adjustment cam 1100 further includes an actuator interface 1108 and a separator 1110 disposed between the shock absorber mounting surface 1104 and the actuator interface.

The cam body 1102 can include a portion defining the shock absorber mounting surface 1104. In the embodiment shown in FIG. 11, the cross-sectional shape of the portion defining shock mounting surface 1104 is circular. Other cross-sectional shapes are possible, corresponding to a shape of the portion of the shock absorber engaging with adjustment cam 1100. The attachment aperture 1106 extends through the cam body 1102. In the portion of the cam body 1102 defining the shock absorber, a center of the cross-sectional shape of cam body 1102 can be offset from a center of the attachment aperture 1106. The size of the cam body 1102, the size of the attachment aperture 1106, and the length of the offset between the center of the cross-sectional shape of cam body 1102 and the center of attachment aperture 1106 can be selected to provide a predetermined range of travel for the end of the shock absorber relative to the shaft 1002 of a front torque arm 1000 including the adjustment cam 1100.

Actuator interface 1108 is a feature configured to engage with an actuator, such as cam actuator 1014 described above, such that cam body 1102 can be rotated about a fastener extending through attachment aperture 1106. The actuator interface 1108 can be, for example, a gear configured to engage a corresponding gear of the cam actuator 1014. Divider 1110 can separate the actuator interface 1108 from shock mounting surface 1104, to prevent the shock absorber from interfering with actuator interface 1108 or cam actuator 1014. The divider 1112 can include one or more cam stops 1112. Cam stops 1112 can be configured to contact one or more features, such as features formed on the attached shock absorber, shaft 1002, one or more projections from cam supports 1008, or the like, to limit the rotation of adjustment cam 1100 to a fixed range of travel. The cam stops 1112 can reduce an extent to which forces on the shock absorber are transferred to the cam actuator 1014 by interface with the contacted feature(s).

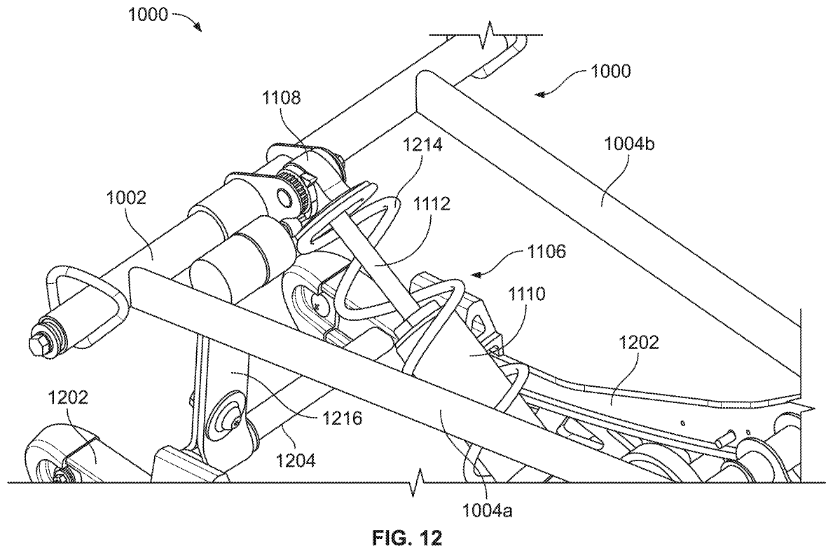

FIG. 12 shows an example snowmobile suspension system including the example front torque arm of FIG. 10. Suspension system 1200 includes lower rails 1202 and lower rail cross shaft 1204. The suspension system 1200 further includes front torque arm 1000 as described above and shown in FIG. 10. The suspension system 1200 also includes shock absorber 1206 including attachment point 1208, hydraulic cylinder 1210, shaft 1212 and spring 1214. Optionally, a limiter strap 1216 can be attached to lower rail cross shaft 1204 and the shaft 1002 of front torque arm 1000.

Lower rails 1202 are configured to support and guide an endless belt of the snowmobile, such as endless belt 214 described above and shown in FIG. 2. The position of the lower rails 1202 relative to the shaft 1002 of front torque arm 1000 can affect the ride and handling characteristics of the snowmobile including suspension system 1200. Lower rail cross shaft 1204 can extend between lower rails 1202 towards a front end thereof. Links 1004a, 1004b of the front torque arm 1000 can be rotatably coupled to the lower rails 1002. The position of shaft 1002 relative to the lower rails 1202 can be regulated by shock absorber 1206. Cam 1010 can be attached to cam supports 1008 by way of a fastener 1216. The fastener 1216 can extend through fastener opening 1012 as discussed above and shown in FIG. 10. A portion of fastener opening 1012 formed in cam 1010 can be provided by an attachment aperture 1006 as discussed above and shown in FIG. 10.

Shock absorber 1206 is connected to lower rails 1202, and to front torque arm 1000. The attachment of shock absorber 1206 to front torque arm 1000 can be provided by way of engagement of the attachment point 1208 to the cam 1010 included in front torque arm 1000. The attachment point can include a cylindrical aperture configured to receive the cam 1010, or any other suitable shape for interfacing with cam 1010. The position of attachment point 1208 relative to shaft 1002 of the front torque arm 1000 can be changed by rotation of the cam 1010 by cam actuator 1014. The change in position can be provided by an attachment aperture 1006 provided in cam 1010 being offset from a center of the cross-section of the portion of cam 1010 where attachment point 1208 engages cam 1010. The adjustment of the position of the attachment point 1208 can allow the effective length of shock absorber 1206 to be modified without affecting an actual length of the hydraulic cylinder 1210, shaft 1212 or the spring 1214. In an embodiment, pre-tensioning of the spring 1214 provided in shock absorber 1206 is not affected by movement of the attachment point 1208 relative to shaft 1002. The cam 1010 can be configured to allow the position of attachment point 1208 to be moved relative to the shaft 1002 by a predetermined distance of travel. In an embodiment, the distance of travel can be selected such that a height from lower rails 1202 to shaft 1002 of front torque arm 1000 can be modified up to a maximum travel distance in a range from approximately half an inch to one and one quarter inches by movement of the attachment point 1208 relative to shaft 1002 when using a shock absorber of a given length connected to lower rails 1202 and attachment point 1208.

Optionally a limiter strap 1216 can be provided. Limiter strap 1216 can provide a tensile limiter limiting the distance between shaft 1002 and lower rails 1202, thereby limiting the travel of lower rails 1202 relative to a chassis of the snowmobile. The limiter strap 1216 can have a length selected to correspond to the position of the attachment point 1208 providing the greatest effective length for shock absorber 1206.

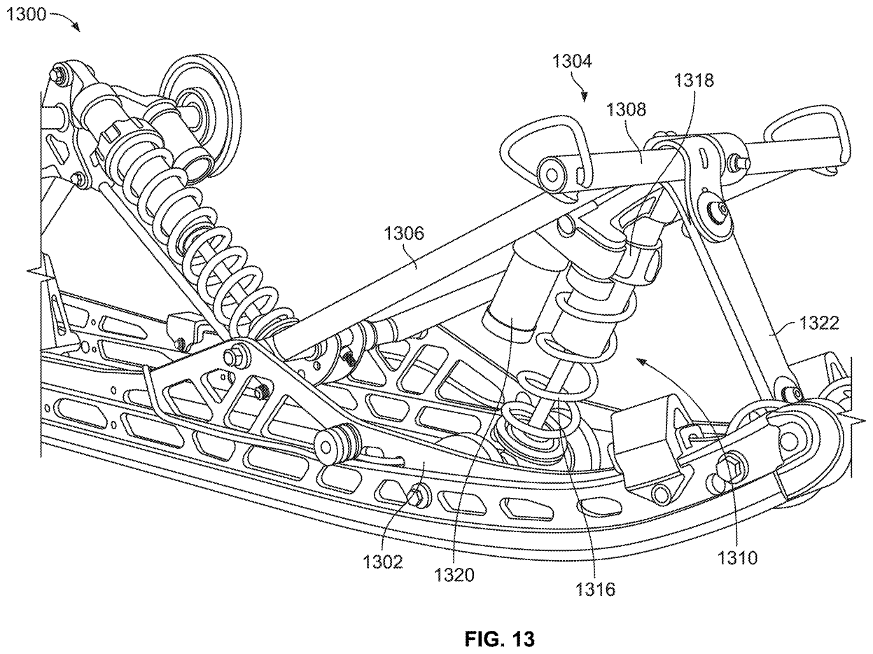

FIG. 13 shows an example snowmobile suspension system including an adjustable front track shock. Snowmobile suspension system 1300 includes lower rails 1302, front torque arm 1304 including links 1306 and a cross shaft 1308, and an adjustable shock absorber 1310 including hydraulic cylinder 1312, shaft 1314, spring 1316, adjustable segment 1318, and fluid reservoir 1320.

Adjustable shock absorber 1310 is configured to regulate the position of lower rails 1302 relative to cross shaft 1308. The adjustable shock absorber 1310 is configured such that a length of the shock absorber can be varied with reduced or no effect on damping characteristics and/or pretension of the spring 1316. The adjustable shock absorber 1310 can be configured such that the change in length of the adjustable shock absorber allows a height from the lower rails 1302 to the cross shaft 1308 can be modified when the vehicle is under consistent load at standard loading conditions. In an embodiment, the adjustable shock absorber 1310 can be configured to provide a change in the height from lower rails 1302 to cross shaft 1308 of up to one and one quarter inches. In an embodiment, the adjustable shock absorber 1310 can be configured to provide a change in the height from lower rails 1302 to shaft 1308 of up to one half an inch.

Adjustable shock absorber 1310 includes cylinder 1312, shaft 1314 and spring 1316 to provide shock absorption. The adjustable shock absorber 1310 further includes adjustable segment 1318 and fluid reservoir 1320. Adjustable segment 1318 can be provided at an end of the adjustable shock absorber 1310, for example at an end attaching to the bottom rail 1302 or an end attaching to front rail 1308 as shown in FIG. 13. The adjustable segment 1318 can be positioned outside of the length of adjustable shock absorber 1310 over which spring 1316 extends. Adjustable shock absorber 1310 can be extended or retracted without affecting spring pre-tension characteristics of the adjustable shock absorber 1310. In an embodiment, the adjustable segment 1318 can be adjusted without modifying the damping properties of adjustable shock absorber 1310. The adjustable segment 1318 can be hydraulically actuated. In an embodiment, the adjustable segment 1318 can be actuated using a separate hydraulic fluid from the hydraulic fluid contained within cylinder 1312. At least some of the hydraulic fluid used for actuation of adjustable segment 1318 can be contained within reservoir 1320 in at least some positions of adjustable segment 1318. The reservoir 1320 can be in fluid communication with a volume within adjustable segment 1318.

In an embodiment, the length of the adjustable shock absorber 1310 can be the sole feature controlling the position of the lower rails 1302 relative to cross shaft 1308, such that limiter strap 1322 can be omitted from the snowmobile suspension system 1300. In such embodiments, no limiter strap 1322 is present.

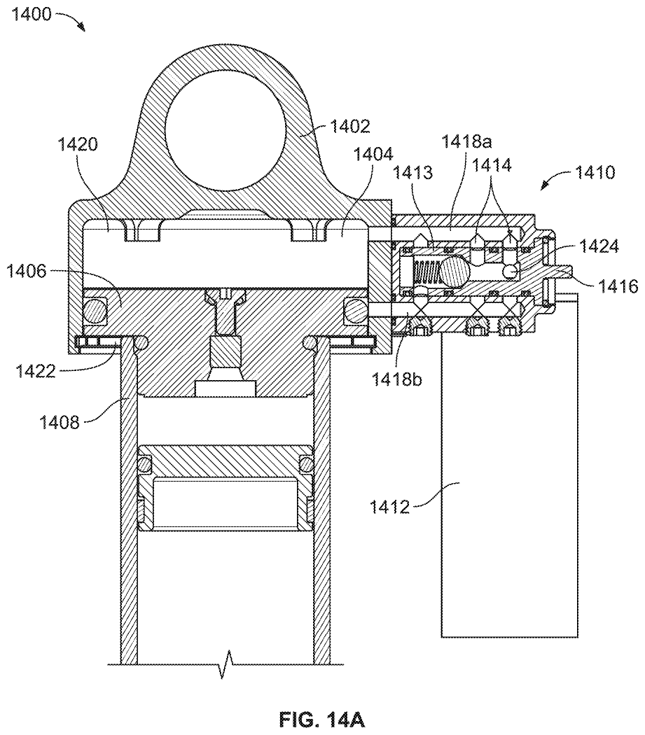

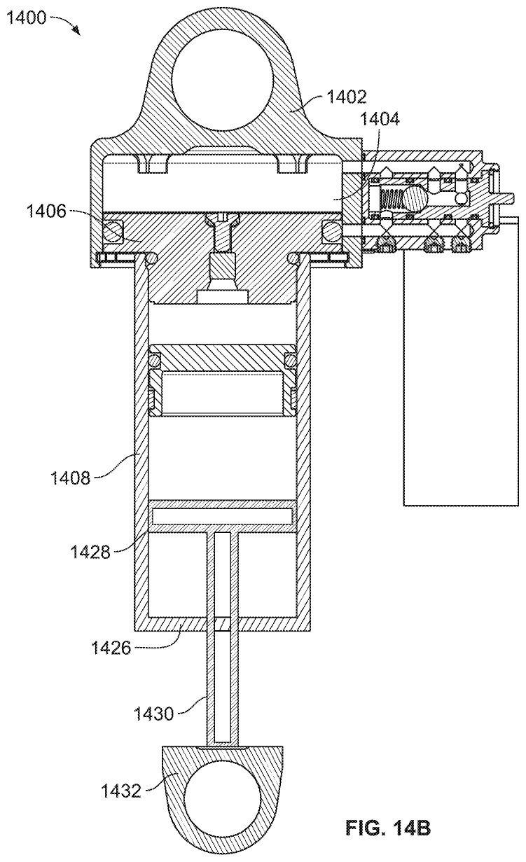

FIG. 14A shows a sectional view of an adjustable front track shock according to an embodiment. Adjustable front track shock 1400 includes shock attachment 1402 defining an adjustment volume 1404. Adjustment piston 1406 is movable within the adjustment volume 1404. An end of shock absorber cylinder 1408 is connected to the adjustment piston 1406. Fluid within the adjustment volume 1404 can be regulated by valve assembly 1410 and reservoir 1412. Valve assembly 1410 can include a rotating segment 1413 including ports 1414 and adjustment projection 1416. Ports 1414 can communicate with fluid passages 1418a,b, connecting to different regions of the adjustment volume 1404 relative to the adjustment piston 1406.

Shock attachment 1402 is configured to encircle a shaft, such as a cross shaft of a front torque arm, a cross shaft extending between lower rails of a snowmobile, or the like. Shock attachment 1402 can be provided on a body defining adjustment volume 1404. The adjustment volume 1404 is a space configured to contain hydraulic fluid and adjustment piston 1406, such that adjustment piston 1406 can be movable in a length direction of adjustable front track shock 1400. Adjustment piston 1406 can support an end of the adjustable shock absorber 1400, for example an end of cylinder 1408, such that the position of adjustment piston 1406 can dictate the distance between the end of the cylinder or shaft and the shock attachment 1402. The change in position of adjustment piston 1406 can thereby control an effective length of the adjustable shock absorber 1400. The change in effective length of adjustable shock absorber 1400 can be used to control relative positions of lower rails and a front torque arm in a snowmobile.

In adjustable shock absorber 1400, the position of adjustment piston 1406 within adjustment volume can be regulated using valve assembly 1410 and reservoir 1412. Valve assembly 1410 is configured to selectively allow fluid communication between a first space 1420 on a first side of the adjustment piston 1404 and reservoir 1412, or a second space 1422 on a second side of the adjustment piston 1404, opposite the first, and the reservoir 1412. Valve assembly 1410 can include a rotating segment 1413 including ports 1414 and adjustment projection 1416. Adjustment projection 1416 can be an engagement feature allowing the rotating segment 1413 to be driven to rotate. For example, adjustment projection 1416 can be manually controllable, interfaced with by an electrically powered actuator such as a servo or stepper motor, or the like. Ports 1414 can be provided in particular radial positions so as to communicate with fluid passages 1418a or 1418b depending on the rotational position of rotating segment 1413. Fluid passages 1418a can communicate with first space 1420 and fluid passages 1418b can communicate with second space 1422. In an embodiment, a portion of adjustment piston 1406 such as a seal provided thereon can obstruct one of fluid passages 1418a or fluid passages 1418b. The rotating segment 1413 can have a first position where ports 1414 are configured to retain fluid in its current position within adjustment volume 1404, a second position where ports 1414 are configured to allow fluid to pass from the first space 1420 to the second space 1422 and/or reservoir 1412 when the adjustable shock absorber 1400 is stroked, and a third position where ports 1414 are configured to allow fluid to pass from second space 1422 to first space 1420 and/or reservoir 1412 when the adjustable shock absorber 1400 is extended, for example due to weight transfer during acceleration or the like. Reservoir port 1424 can provide communication between the valve assembly 1410 and reservoir 1412, for example to allow fluid to pass into or out of reservoir 1412 to take up or return some of the fluid during adjustment of the length of the adjustable shock absorber 1400.

FIG. 14B shows a full length of adjustable shock absorber 1400. Cylinder 1408 includes an end 1426. End 1426 of cylinder 1408 can provide a stop limiting movement of piston 1428, which is attached to a shaft 1430 having a second shock attachment 1432 disposed at an end thereof. The second shock attachment 1432 can attach to one of a front torque arm or a lower rail assembly, opposite the shock attachment 1402. A distance between the end 1426 of cylinder 1408 and the shock attachment 1402 can be changed by providing hydraulic fluid in the adjustment space 1404 to control a position of adjustment piston 1406. The change in distance from the shock attachment 1402 to end 1426 of cylinder can affect the length of the adjustable shock absorber 1400 when fully extended as end 1426 defines a length of piston 1428 capable of extending from cylinder 1408.

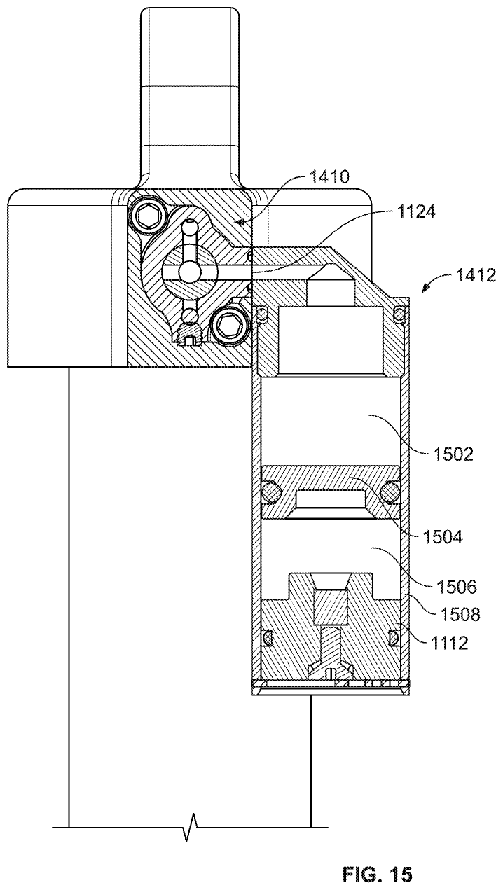

FIG. 15 shows a second sectional view of the adjustable front track shock of FIG. 14A. Reservoir 1412 includes fluid space 1502, movable piston 1504, buffer space 1506, and reservoir body 1508. Fluid space 1502 can contain hydraulic fluid shared with adjustment volume 1404, for example to take up excess fluid displaced from the adjustment volume 1404 during changes in position of the adjustment piston 1406. The fluid space 1202 can be defined by movable piston 1504 and reservoir body 1508. Buffer space 1506 can be defined by reservoir body 1508 and an opposite side of movable piston 1504 from first fluid space 1202. Buffer space 1506 can contain a pressurized gas, such as nitrogen. The gas in the buffer space 1506 can provide pressure for returning at least some fluid from the fluid space 1502 to the adjustment volume 1404.

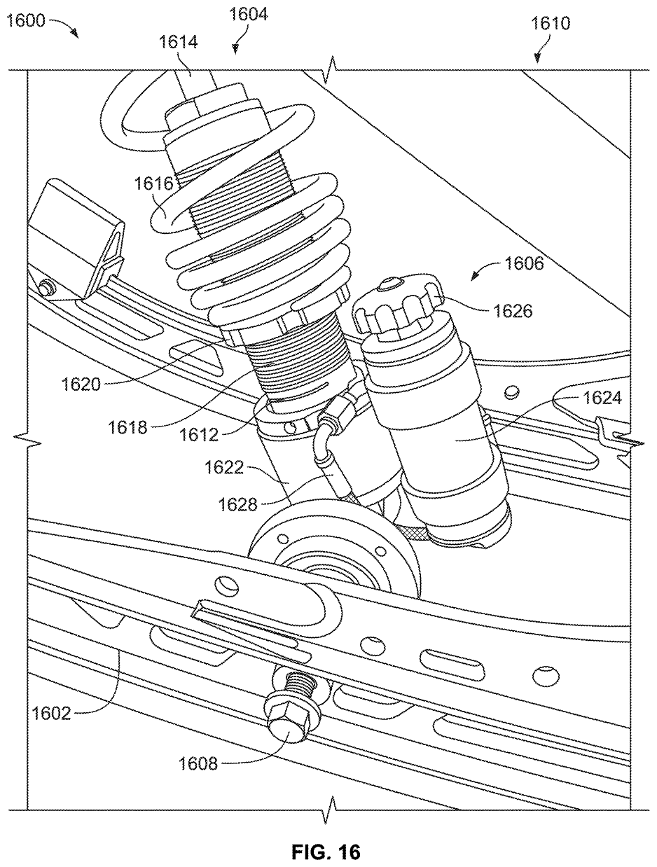

FIG. 16 shows a side view of an example snowmobile suspension system including an adjustable front track shock. Snowmobile suspension system 1600 includes lower rails 1602, shock absorber 1604, and shock absorber length adjuster 1606. Shock absorber 1604 can connect to lower rails 1602 along shaft 1608. Shock absorber 1604 can further connect to front torque arm 1610, for example at a cross shaft thereof such as the cross shaft 208 as shown in FIG. 2 and discussed above.

Shock absorber 1604 includes cylinder 1612, shaft 1614, and spring 1616. Cylinder 1612 can include threading 1618 allowing a fitting 1620 of the spring 1616 to be secured at a position to provide a desired pre-tension on the spring 1616.

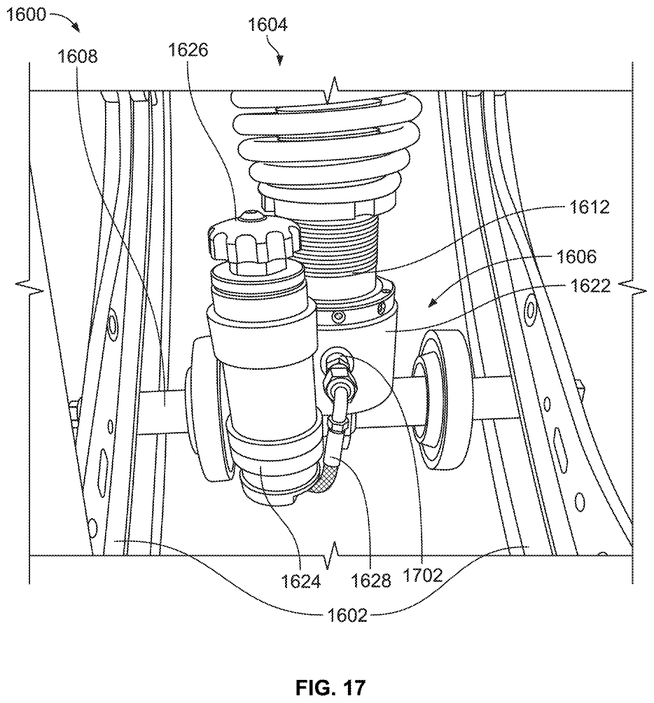

Shock absorber length adjuster 1606 can include shock attachment 1622, a reservoir 1624, an adjustment control 1626, and fluid connection 1628. Shock attachment 1622 can include a volume configured to receive hydraulic fluid so as to adjust or maintain a position of a piston provided therein, with the piston controlling the position of the shock attachment 1622 relative to an end of the shock absorber 1604, for example an end of the cylinder 1612 or an end of the shaft 1614. The movement of shock attachment 1622 relative to the end of the shock absorber 1604 can alter an effective length of the shock absorber 1604. A change in effective length of the shock absorber 1604 can alter the distance from a cross shaft of the front torque arm 1610 to the lower rails 1602, thereby altering the ride characteristics of the snowmobile. FIG. 17 shows a rear view of the example adjustable front track shock of FIG. 16. Fluid connection 1628 can connect to the shock attachment 1622 at coupling 1702.

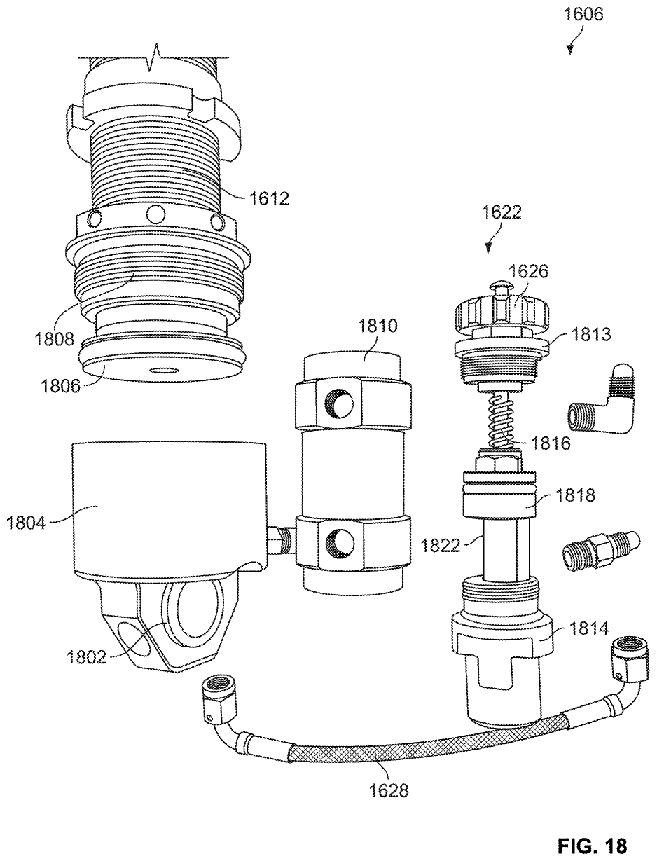

FIG. 18 shows an exploded view of the example adjustable front track shock adjuster 1606. Shock attachment 1622 includes an attachment feature 1802, length adjustment cylinder 1804, length adjustment piston 1806, and length adjustment cylinder closure 1808. Attachment feature 1802 allows the shock absorber 1604 to be coupled to a snowmobile, for example by surrounding a cross shaft provided between lower rails 1602 or provided in front torque arm 1610. The length adjustment cylinder 1804 is a cylinder containing a hydraulic fluid and the length adjustment piston 1806. The hydraulic fluid of length adjustment cylinder 1804 is a separate fluid from the fluid of shock absorber 1604. The position of length adjustment piston 1806 within length adjustment cylinder 1804 can be controlled by a volume of the hydraulic fluid provided in length adjustment cylinder. The length adjustment piston 1806 can be coupled to an end of the shock absorber 1604.

Reservoir 1624 can include reservoir body 1810, first reservoir closure fitting 1813, and second reservoir closure fitting 1814, which can cooperate to define a reservoir space. Reservoir body 1810 is configured to store hydraulic fluid, which can be received from or provided to length adjustment cylinder 1804 selectively to adjust a position of length adjustment piston 1806 and thereby alter an effective length of the shock absorber 1604. Adjustment control 1626 can be provided on an outside of first reservoir closure fitting 1813. The adjustment control 1626 can be coupled to threaded shaft 1816 so as to drive rotation of threaded shaft 1816, for example by manual rotation of a knob, operation of an actuator such as a servo motor, or the like. Reservoir piston 1818 can include corresponding threading such that rotation of the threaded shaft 1816 causes linear translation of the reservoir piston 1818 within reservoir body so as to increase or reduce the available volume within reservoir body 1810. In an embodiment, reservoir piston 1818 can include guide projections 1822 configured to be received within corresponding features of the second reservoir closure fitting 1814.

Fluid connection 1628 can provide communication between the volume within reservoir body 1810 and the volume within length adjustment cylinder 1804, such that movement of the reservoir piston 1818 can control the volume of fluid present in the volume within length adjustment cylinder 1804. The fluid within the volume within length adjustment cylinder 1804 can determine the position of length adjustment piston 1806, thereby controlling the length of the shock absorber 1604 received within the length adjustment cylinder closure 1808.

In an embodiment, shock absorber length adjuster 1606 can be provided as an installable component capable of use with an existing front torque arm shock absorber of an existing snowmobile, such as a kit for retrofitting existing snowmobiles to provide an adjustable length shock. In such embodiments, the shock absorber length adjuster 1606 can be configured that the length adjustment cylinder closure 1808 can receive a portion of a shock absorber at a cylinder or shaft end thereof, and the attachment feature 1802 can be connected to a suitable connection position in the snowmobile.

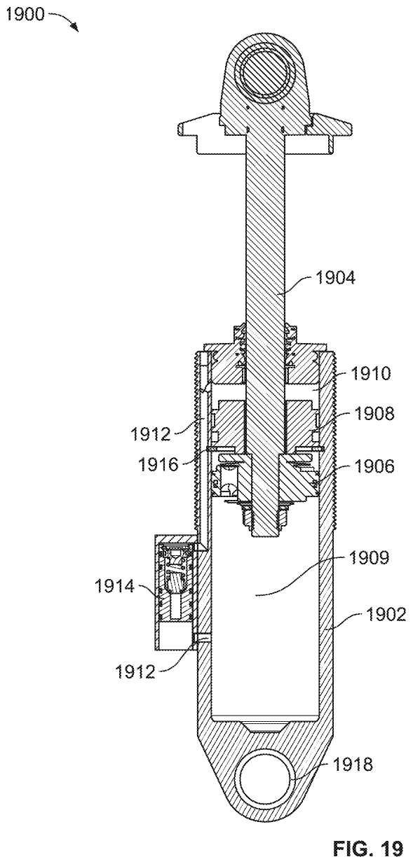

FIG. 19 shows a sectional view of an example adjustable shock absorber. Adjustable shock absorber 1900 includes cylinder 1902 and shock absorber piston 1904 having head 1906. An internal piston 1908 is provided between head 1906 and an end of cylinder 1902. The head 1906 divides the internal space of cylinder 1902 into a first space 1909 and a second space 1910. One or more passages 1912 can provide fluid communication between the first space 1909 and the second space 1910. A valve assembly 1914 can regulate flow through the passages 1912 between first space 1909 and second space 1910.

Internal piston 1908 can regulate an extent to which a shaft of shock absorber piston 1904 protrudes from the end of cylinder 1902, thereby controlling the effective length of shock absorber 1900. The position of the internal piston 1908 can be controlled by the distribution of the hydraulic fluid within cylinder 1902 between the first space 1909 and second space 1910. First space 1909 can be on a side of the head 1906 opposite the internal piston 1908, and second space 1910 can be on a side of the head 1906 where the internal piston 1908 is disposed. The distribution of hydraulic fluid between first and second spaces 1909, 1910 can be controlled by a valve assembly 1914. Valve assembly 1914 can be in communication with each of the first space 1909 and the second space 1910 by way of respective passages 1912. In an embodiment, fluid can only pass from first space 1909 to second space 1910 or vice versa by passing through the valve assembly 1914. Valve assembly 1914 can include one or more check valves to allow flow in only one direction at a time. Valve assembly 1914 can be, for example, push-pull valve 1700 as described below and shown in FIGS. 17A and 17B. Passage of hydraulic fluid through the valve assembly 1914 can be driven by operations of the shock such as compression or extension thereof, for example during normal operations of a snowmobile including adjustable shock absorber 1900.

The cylinder 1902 can include one or more stopping features 1916 such as a shoulder, a flange, or the like configured to limit movement of the internal piston 1908 to a range of adjustment for the adjustable shock absorber 1900. The range of adjustment can be selected such that when the adjustable shock absorber 1900 is coupled to lower rails of a snowmobile and a front torque arm of the snowmobile, the height from the lower rails to a cross shaft of the front torque arm can be modified by up to one and one quarter inches In an embodiment, the range of adjustment can be selected such that when the adjustable shock absorber 1900 is coupled to lower rails of a snowmobile and a front torque arm of the snowmobile, the height from the lower rails to a cross shaft of the front torque arm can be modified by up to one half of one inch.

In operation, the distance from movable piston 1908 to shock absorber attachment 1918 can be modified hydraulically without use of fluid from a reservoir. The movable piston 1906 can be a stop for the shock absorber piston 1904, limiting the extension of the shock absorber piston 1904 from cylinder 1902. Changing the distance between movable piston 1908 to shock absorber attachment 1918 can thereby change an extended length of the adjustable shock absorber 1900. In an embodiment, adjustment of effective length of the shock absorber 1900 can affect a pre-tension of a spring provided with the shock absorber 1900. In an embodiment, the pre-tension of the spring can be selected such that suitable ride properties are maintained at different effective lengths of the shock absorber 1900. In an embodiment, adjustable shock absorber 1900 has consistent damping properties at each of the various effective length settings provided by the adjustable shock absorber 1900.

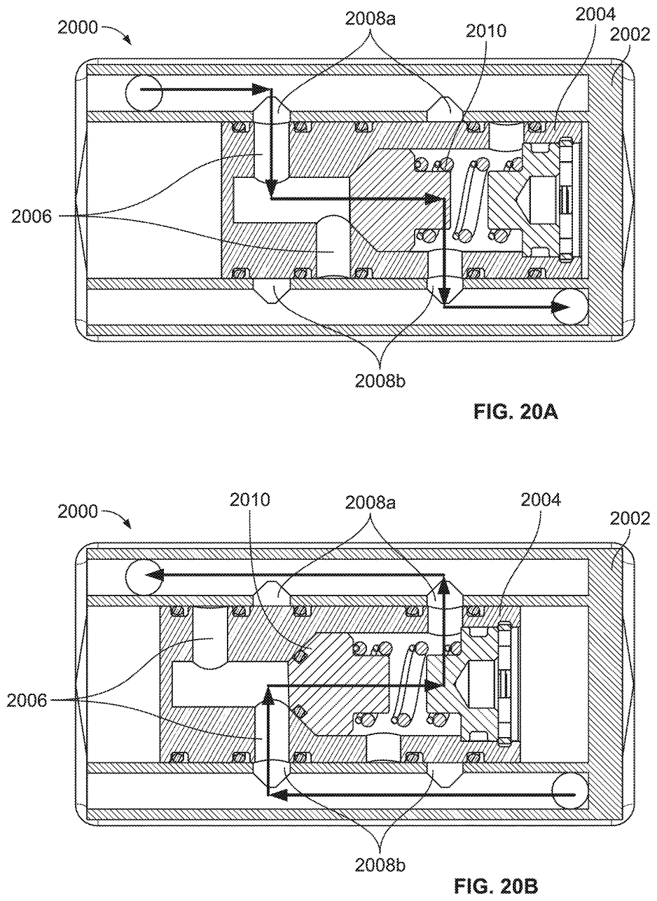

FIG. 20A shows an example valve assembly of the adjustable front track shock of FIG. 19 in a first position. Push-pull valve 2000 is an example of a valve assembly capable of being used as the valve assembly 1914 of adjustable front track shock 1900. Push-pull valve 2000 includes a sliding segment 2002 and a fixed segment 2004. Sliding segment 2002 includes ports 2006. Fixed segment 2004 includes a first plurality of ports 2008a in communication with the first space 1909 and a second plurality of ports 2008b in communication with the second space 1910. A check valve 2010 is provided in push-pull valve 2000. When in the first position as shown in FIG. 20A, the sliding segment 2002 is positioned within fixed segment 2004 such that the respective ports 2006, 2008a, and 2008b and check valve 2010 provide a flow path allowing fluid to pass from the first space 1909 to the second space 1910. When the adjustable shock absorber 1900 is compressed while push-pull valve 2000 is in the first position as shown in FIG. 20A, fluid can be driven from the first space 1909 to the second space 1910, moving the internal piston 1908 to shorten an effective length of the shock.

FIG. 20B shows the example push-pull valve of FIG. 20A in a second position. In the second position, the sliding segment 2002 is positioned within fixed segment 2004 such that the respective ports 2006, 2008a, and 2008b and check valve 2010 provide a flow path allowing fluid to pass from the second space 1910 to the second space 1908. When the adjustable shock absorber 1900 is extended while push-pull valve 2000 is in the second position as shown in FIG. 20B, for example during weight transfer during acceleration or the like, fluid can be driven from the second space 1910 to the first space 1909, moving the internal piston 1908 to lengthen the effective length of the shock absorber 1900. The sliding segment 2002 of push-pull valve 2000 can be movable between the first and second positions by any suitable actuation, such as a feature for manual movement of the sliding segment 2002, a mechanical actuator, an electrically powered actuator, or the like.

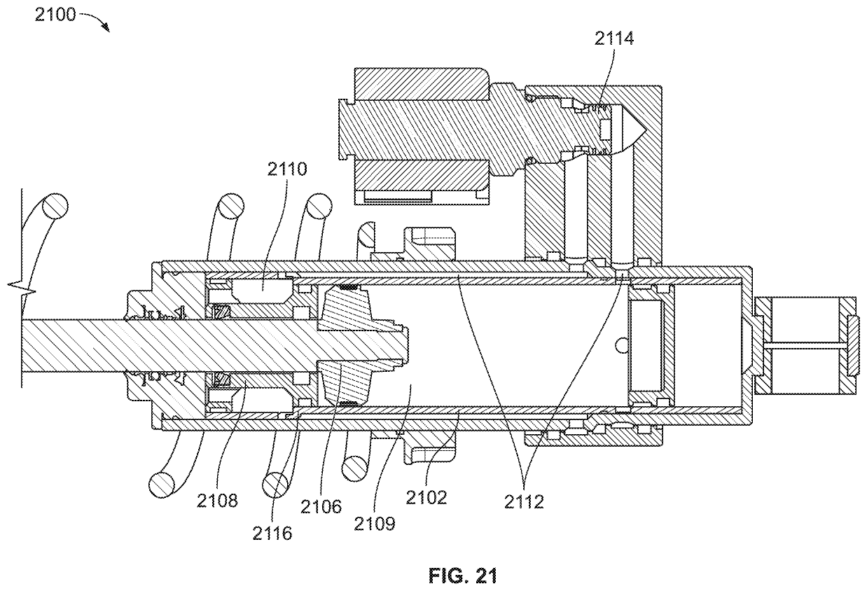

FIG. 21 shows a sectional view of an example adjustable shock absorber. Adjustable shock absorber 2100 can be used in a snowmobile suspension system, for example, between a front torque arm and lower rails of the snowmobile. Adjustable shock absorber 2100 includes cylinder 2102 and shock absorber piston 2104 having head 2106. An internal piston 2108 is provided between head 2106 and an end of cylinder 2102. The head 2106 divides the internal space of cylinder 2102 into a first space 2109 and a second space 2110. One or more passages 2112 can provide fluid communication between the first space 2109 and the second space 2110. A valve assembly 2114 can regulate flow through the passages 2112 between first space 2109 and second space 2110.

Internal piston 2108 can regulate an extent to which a shaft of shock absorber piston 2104 protrudes from the end of cylinder 2102, thereby controlling the effective length of shock absorber 2100. The position of the internal piston 2108 can be controlled by the distribution of the hydraulic fluid within cylinder 2102 between the first space 2109 and second space 2110. First space 2109 can be on a side of the head 2106 opposite the internal piston 2108, and second space 2110 can be on a side of the head 2106 where the internal piston 2108 is disposed. The distribution of hydraulic fluid between first and second spaces 2109, 2110 can be controlled by a valve assembly 2114. Valve assembly 2114 can be in communication with each of the first space 2109 and the second space 2110 by way of respective passages 2112. In an embodiment, fluid can only pass from first space 2109 to second space 2110 or vice versa by passing through the valve assembly 2114. Valve assembly 2114 can include one or more check valves to allow flow in only one direction at a time. In example adjustable shock absorber 2100, the valve assembly 2114 is a solenoid check valve configured to allow flow from the first space 2109 to the second space 2110 and prohibit flow from the second space 2110 to the first space 2109 when in a first position. In the first position, pumping of the shock absorber 2100 can drive hydraulic fluid to the second space, thereby moving internal piston 2108 and reducing an effective length of shock absorber 2100. The solenoid check valve of valve assembly 2114 can be actuated to a second position where the valve assembly allows flow freely between the first and second spaces 2109, 2110, for example when power is supplied to the solenoid check valve. In the second position, the adjustable shock absorber 2100 can extend to a full length thereof. The internal piston 2108 can travel with head 2106 of the shock absorber piston 2104 when the adjustable shock absorber 2100 is pumped. In another example, valve assembly 2114 can be a dual check cartridge valve, or any other suitable directional control valve.

The cylinder 2102 can include one or more stopping features 2116 such as a shoulder, a flange, or the like configured to limit movement of the internal piston 2108 to a range of adjustment for the adjustable shock absorber 2100. The range of adjustment can be selected such that when the adjustable shock absorber 2100 is coupled to lower rails of a snowmobile and a front torque arm of the snowmobile, the height from the lower rails to a cross shaft of the front torque arm can be modified by up to one and one quarter inches In an embodiment, the range of adjustment can be selected such that when the adjustable shock absorber 2100 is coupled to lower rails of a snowmobile and a front torque arm of the snowmobile, the height from the lower rails to a cross shaft of the front torque arm can be modified by up to one half of one inch.

In an embodiment, adjustment of effective length of the shock absorber 2100 can affect a pre-tension of a spring provided with the shock absorber 2100. In an embodiment, the pre-tension of the spring can be selected such that suitable ride properties are maintained at different effective lengths of the shock absorber 2100. In an embodiment, adjustable shock absorber 2100 has consistent damping properties at each of the various effective length settings provided by the adjustable shock absorber 2100.

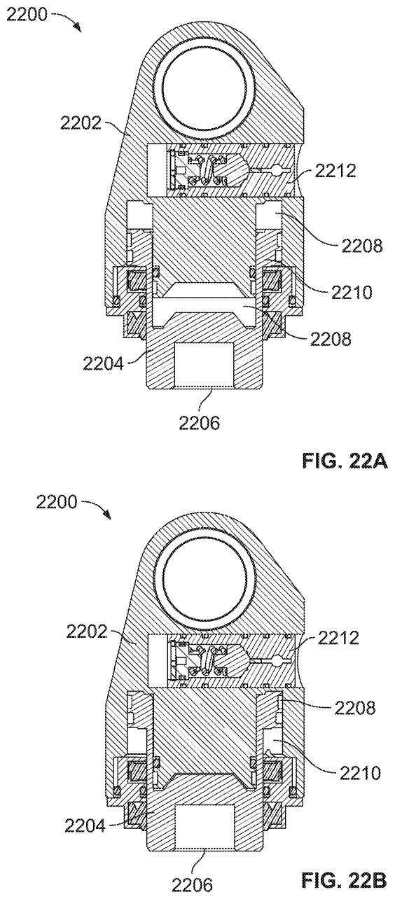

FIG. 22A shows an example shock absorber length adjuster in a first position. Shock absorber length adjuster 2200 includes shock absorber attachment body 2202 and piston 2204. Piston 2204 includes shock absorber shaft receptacle 2206 configured to receive an end of a shaft of a shock absorber, such as a shock absorber for a front torque arm of a snowmobile. Shock absorber attachment body 2202 and piston 2204 define first space 2208 and second space 2210. Valve assembly 2212 is configured to control flow of hydraulic flid from first space 2208 to second space 2210. Valve assembly 2212 can include one or more check valves. In embodiments, valve assembly 2212 can be a push-pull valve, a rotating valve assembly, a solenoid valve, or any other such suitable valve assembly. In a first position, valve assembly 2212 can allow fluid to flow from second space 2210 to first space 2208 and prohibit fluid flow from first space 2208 to second space 2210. Hydraulic fluid thus can be driven to first space 2208, for example when the shock absorber is extended. When hydraulic fluid is in the first space 2208, the distance from an end of shock absorber attachment body 2202 to the position of the shock absorber shaft receptacle 2206 can be increased, thereby increasing an effective length of the shock absorber joined to shock absorber length adjuster 2200.

FIG. 22B shows the example shock absorber length adjuster of FIG. 22A in a second position. In the second position, hydraulic fluid can pass from first space 2208 to second space 2210, while flow from second space 2210 to first space 2208 is prohibited. In FIG. 22B, hydraulic fluid has been transferred to the second space 2210 through valve assembly 2212, reducing a distance from an end of shock absorber attachment body 2202 to the position of the shock absorber shaft receptacle 2206, thereby reducing an effective length of the shock absorber joined to shock absorber length adjuster 2200. In an embodiment, the difference between the shortest and longest effective lengths can be selected such that when the shock absorber length adjuster 2200 is installed in a shock absorber connecting lower rails of a snowmobile to a front torque arm thereof, in the height from lower rails to a shaft of the front torque arm can be varied by up to one and one quarter inches. In an embodiment, the difference between the shortest and longest effective lengths can be selected such that when the shock absorber length adjuster 2200 is installed in a shock absorber connecting lower rails of a snowmobile to a front torque arm thereof, in the height from lower rails to a shaft of the front torque arm can be varied by up to one half of an inch.

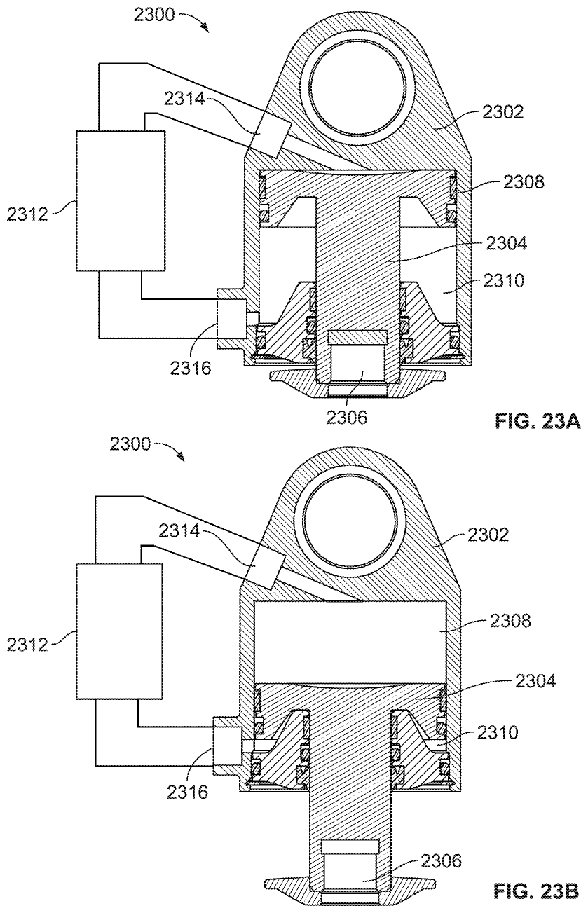

FIG. 23A shows an example shock absorber length adjuster in a first position. Shock absorber length adjuster 2300 includes shock absorber attachment body 2302 and piston 2304. Piston 2304 includes shock absorber shaft receptacle 2306 configured to receive a shaft of shock absorber configured to receive an end of a shaft of a shock absorber, such as a shock absorber for a front torque arm of a snowmobile. Shock absorber attachment body 2302 and piston 2304 define first space 2308 and second space 2310. An accumulator 2312 can be provided. A first port 2314 in communication with first space 2308 and a second port 2316 in communication with second space 2310 can be connected to accumulator 2312. Suitable valves, actuators, and the like can be provided to pump hydraulic fluid from accumulator 2312 to first space 2308 and second space 2310 or from first space 2308 or second space 2310 to accumulator 2312. The hydraulic fluid respectively within first space 2308 and second space 2310 can control a distance from an end of shock absorber attachment body 2302 to the position of the shock absorber shaft receptacle 2306. In the embodiment shown in FIG. 23A, the hydraulic fluid is provided in second space 2310, providing the shortest effective length to the shock absorber attached at shock absorber shaft receptacle 2306 over the range of variation provided by shock absorber length adjuster 2300. FIG. 23B shows the example shock absorber length adjuster of FIG. 23A in a second position. In the embodiment shown in FIG. 23B, the hydraulic fluid is provided in first space 2308, providing the longest effective length to the shock absorber attached at shock absorber shaft receptacle 2306 over the range of variation provided by shock absorber length adjuster 2300. In an embodiment, the difference between the shortest and longest effective lengths can be selected such that when the shock absorber length adjuster 2300 is installed in a shock absorber connecting lower rails of a snowmobile to a front torque arm thereof, in the height from lower rails to a shaft of the front torque arm can be varied by up to one and one quarter inches. In an embodiment, the difference between the shortest and longest effective lengths can be selected such that when the shock absorber length adjuster 2300 is installed in a shock absorber connecting lower rails of a snowmobile to a front torque arm thereof, in the height from lower rails to a shaft of the front torque arm can be varied by up to one half of an inch.

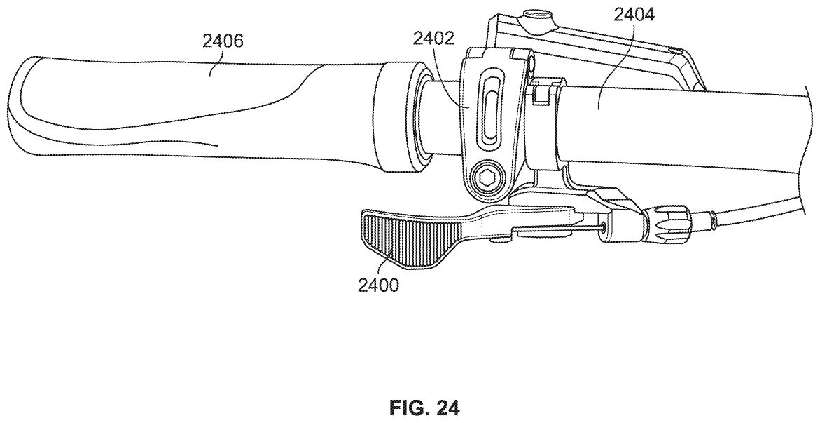

FIG. 24 shows an example handlebar-mounted control. Control 2400 can be attached to a mounting 2402 configured to be mounted to a handlebar 2404. The mounting 2402 can be, for example, a clip, a bracket, or any other such suitable mounting capable of being connected to a handlebar 2404. The handlebar 2404 can be, for example, handlebar 118 of steering system 114 of a snowmobile 100 as described above and shown in FIG. 1. Mounting 2402 can present control 2400 on handlebar 2404 such that a user can operate the control 2400 while operating the snowmobile including handlebar 2404. For example, mounting 2402 can be provided proximal to grip 2406, such that a rider holding on to grip 2406 can manipulate control 2400. Control 2400 is a control configured to operate an actuator for adjusting an effective shock length or an effective limiter strap length for the snowmobile. For example, control 2400 can be connected to limiter strap actuator 610, cam actuator 1014, a hydraulic actuator for a controllable length shock absorber as shown in FIGS. 12-18, one or more valves or switches controlling the lengthening or shortening of the shock absorber, or the like. In an embodiment, control 2400 can be an interface for electronic control of an actuator, such as one or more buttons, a dial, or the like. In an embodiment, control 2400 includes two or more discrete positions, such as the toggleable switch shown in FIG. 24. In an embodiment, control 2400 can allow for continuous control within boundaries of a range, for example being a manually adjusted dial, a dial or one or more buttons controlling an electronic actuator, or the like.

In an embodiment, adjustable length limiter straps or adjustable effective length shock absorbers as described herein can be combined with control systems for shock absorber damping characteristics such as a suspension control module. In such combinations, the adjustable length limiter straps or adjustable effective length shock absorbers can be controlled using a same interface or be co-located with controls for the suspension control module.

### Aspects

It is understood that any of aspects 1-14 can be combined with any of aspects 15-20, 21-28, 29-35, 36-44, 45-53, or 54-61. It is understood that any of aspects 15-20 can be combined with any of aspects 21-28, 29-35, 36-44, 45-53, or 54-61. It is understood that any of aspects 21-28 can be combined with any of aspects 29-35, 36-44, 45-53, or 54-61. It is understood that any of aspects 29-35 can be combined with any of aspects 36-44, 45-53, or 54-61. It is understood that any of aspects 36-44 can be combined with any of aspects 45-53, or 54-61. It is understood that any of aspects 45-53 can be combined with any of aspects 54-61.

Aspect 1. A snowmobile comprising:
a suspension system including a lower rail assembly and a front torque arm including a cross shaft and one or more links rotatably attached to the lower rail assembly;
a control interface configured to receive an operating mode and, in response to receiving the operating mode, provide an electronic control signal; and
an actuator configured to receive the electronic control signal and control a maximum height of the cross shaft relative to the lower rail assembly in response to the electronic control signal.

Aspect 2. The snowmobile according to aspect 1, wherein the control interface includes a selector provided on a handlebar of the snowmobile.

Aspect 3. The snowmobile according to any of aspects 1-2, wherein the control interface includes a display showing a user interface.

Aspect 4. The snowmobile according to any of aspects 1-3, wherein the control interface is configured to receive a user selection of an operating mode, and to provide the electronic control signal in response to the user selection of the operating mode.

Aspect 5. The snowmobile according to any of aspects 1-4, wherein the control interface includes a controller configured to determine an operating mode and provide the electronic control signal based on the determined operating mode.

Aspect 6. The snowmobile according to aspect 5, wherein the controller is configured to determine the operating mode based on one or more of acceleration of the snowmobile, pitch of the snowmobile, power output of an engine of the snowmobile, position of one or more shock absorbers of the snowmobile, input at a brake of the snowmobile, and input at a throttle of the snowmobile.

Aspect 7. The snowmobile according to any of aspects 1-6, wherein the actuator includes a first fluid space, a second fluid space, and a valve assembly including a check valve, wherein the valve assembly is configured to regulate flow between the first fluid space and the second fluid space, and wherein the valve assembly is configured to respond to the electronic control signal.

Aspect 8. The snowmobile according to aspect 7, wherein the check valve is a solenoid check valve.

Aspect 9. The snowmobile according to any of aspects 7-8, wherein the actuator includes an arm attached to a piston including at least a portion disposed in the first fluid space, the arm coupled to a limiter strap, the limiter strap coupled to one of the lower rail assembly or the cross shaft, wherein adding or removing fluid from the first fluid space moves the piston so as to extend or retract the arm.

Aspect 10. The snowmobile according to any of aspects 7-8, wherein the first fluid space and the second fluid space are each provided within a cylinder of an adjustable shock absorber coupled to the lower rail assembly and to the cross shaft, wherein the first fluid space and the second fluid space are divided by a piston of the adjustable shock absorber, and wherein an internal piston is disposed within the first fluid space.

Aspect 11. The snowmobile according to any of aspects 1-9, further comprising a limiter strap coupled to the actuator and the lower rail assembly, wherein the actuator is a limiter strap adjuster configured to extend or retract the limiter strap so as to modify a length of the limiter strap extending from the cross shaft to the lower rail assembly in response to the electronic control signal.

Aspect 12. The snowmobile according to any of aspects 1-7, further comprising a shock absorber mounting adjustment assembly provided on the cross shaft, the shock absorber mounting assembly including:
one or more cam supports configured to receive a fastener; and
a cam including a cam body defining a shock mounting surface and an aperture configured to receive the fastener such that the cam can rotate about the fastener, wherein a center of the cam body defining the shock mounting surface is offset from a center of the aperture,
wherein the actuator is configured to rotate the cam about the fastener.

Aspect 13. The snowmobile according to any of aspects 1-7 or 10, further comprising an adjustable shock absorber coupled to the cross shaft of the front torque arm and coupled to the lower rail assembly, the adjustable shock absorber comprising:
an adjustable segment disposed at an end of the adjustable shock absorber, the adjustable segment defining an adjustment volume;
a piston configured to travel along the adjustment volume to as to increase or decrease an effective length of the adjustable shock absorber; and
a reservoir in fluid communication with the adjustment volume,
wherein the actuator is configured to move fluid from the reservoir to the adjustment volume or from the adjustment volume to the reservoir.

Aspect 14. The snowmobile according to any of aspects 1-7 or 10, further comprising an adjustable shock absorber coupled to the cross shaft of the front torque arm and coupled to the lower rail assembly, the adjustable shock absorber comprising:
a cylinder;
a shaft, the shaft including a piston head provided within the cylinder; and
an internal piston provided in a first space on a first side of the piston head within the cylinder,
wherein the actuator is a valve assembly configured to control flow of fluid from the first side to a second space on a second side of the piston head within the cylinder, the valve assembly configured to allow flow from the second space to the first space and obstruct flow from the first space to the second space in a first mode, and the valve assembly is configured to allow flow from the first space to the second space in a second mode.

Aspect 15. A method of controlling snowmobile ride characteristics, comprising:
receiving, at a control interface, an operating mode for a snowmobile;
transmitting an electronic control signal from the control interface to an actuator in response to receiving the operating mode;
receiving, at an actuator, the electronic control signal; and
operating the actuator in response to the electronic control signal, wherein operating the actuator changes a maximum height of a cross shaft of a front torque arm of a suspension system above a lower rail assembly of the suspension system.

Aspect 16. The method according to aspect 15, further comprising receiving a user input of the operating mode at the control interface.

Aspect 17. The method according to aspect 15, further comprising determining the operating mode for the snowmobile based on one or more of acceleration of the snowmobile, pitch of the snowmobile, power output of an engine of the snowmobile, position of one or more shock absorbers of the snowmobile, input at a brake of the snowmobile, and input at a throttle of the snowmobile.

Aspect 18. The method according to any of aspects 15-17, wherein the actuator is a hydraulic actuator.

Aspect 19. The method according to aspect 18, wherein operating the actuator extends or retracts a limiter strap coupled to the actuator and one of the cross shaft or the lower rail assembly.

Aspect 20. The method according to aspect 18, wherein operating the actuator changes a length of an adjustable shock absorber coupled to the cross shaft and the lower rail assembly.

Aspect 21. A snowmobile suspension system, comprising:
a lower rail assembly;
a front torque arm, the front torque arm including a cross shaft and one or more links rotatably attached to the lower rail assembly;
a shock absorber coupled to the cross shaft and the lower rail assembly; and
a limiter strap adjuster; and
a limiter strap coupled to the limiter strap adjuster and the lower rail assembly, wherein the limiter strap adjuster is configured to extend or retract the limiter strap so as to modify a length of the limiter strap extending from the cross shaft to the lower rail assembly.

Aspect 22. The snowmobile suspension system according to aspect 21, further comprising a limiter strap guide coupled to the cross shaft, the limiter strap guide and the cross shaft defining an opening, the limiter strap passing through said opening.

Aspect 23. The snowmobile suspension system according to any of aspects 21-22, wherein the limiter strap adjuster is hydraulically driven.

Aspect 24. The snowmobile suspension system according to any of aspects 21-23, wherein the limiter strap adjuster is electronically controlled.

Aspect 25. The snowmobile suspension system according to aspect 24, wherein a control of the limiter strap adjuster is configured to be attached to a handlebar of a snowmobile.

Aspect 26. The snowmobile suspension system according to any of aspects 21-25, wherein the limiter strap adjuster is configured to modify the length of the limiter strap such that a maximum height of the cross shaft above the lower rail assembly can be modified by up to one and one quarter inches.

Aspect 27. The snowmobile suspension system according to any of aspects 21-26, wherein the limiter strap adjuster is configured to modify the length of the limiter strap such that a maximum height of the cross shaft above the lower rail assembly can be modified by up to one half of one inch.

Aspect 28. A snowmobile comprising the snowmobile suspension system according to any of aspects 21-27.

Aspect 29. A snowmobile suspension system comprising:
a front torque arm, the front torque arm including:
   a first link;
   a second link;
   a cross shaft extending between the first link and the second link; and
   a shock absorber mounting adjustment assembly provided on the cross shaft, the shock absorber mounting assembly including:
   one or more cam supports configured to receive a fastener;
   a cam including a cam body defining a shock mounting surface and an aperture configured to receive the fastener such that the cam can rotate about the fastener, wherein a center of the cam body defining the shock mounting surface is offset from a center of the aperture; and
   an actuator configured to rotate the cam about the fastener.

Aspect 30. The snowmobile suspension system according to aspect 29, further comprising a limiter strap coupled to the cross shaft.

Aspect 31. The snowmobile suspension system according to aspect 29, wherein the snowmobile suspension system does not include a limiter strap.

Aspect 32. The snowmobile suspension system according to any of aspects 9-31, further comprising a lower rail assembly, wherein the first link and the second link are rotatably connected to the lower rail assembly and a shock absorber is connected to the lower rail assembly and to the cam.

Aspect 33. The snowmobile suspension system according to aspect 32, wherein the shock absorber mounting adjustment assembly is configured such that a maximum height of the cross shaft above the lower rail assembly can be modified by up to one and one quarter inches.

Aspect 34. The snowmobile suspension system according to aspect 32, wherein the shock absorber mounting adjustment assembly is configured such that a maximum height of the cross shaft above the lower rail assembly can be modified by up to one half of one inch.

Aspect 35. A snowmobile including the snowmobile suspension system according to any of aspects 29-34.

Aspect 36. A snowmobile suspension system, comprising:
a lower rail assembly;
a front torque arm, the front torque arm including:
   a cross shaft; and
a plurality of links coupled to the cross shaft, each of the plurality of links rotatably coupled to the lower rail assembly; and
an adjustable shock absorber coupled to the cross shaft of the front torque arm and coupled to the lower rail assembly, the adjustable shock absorber comprising:
   an adjustable segment disposed at an end of the adjustable shock absorber, the adjustable segment defining an adjustment volume;
   a piston configured to travel along the adjustment volume to as to increase or decrease an effective length of the adjustable shock absorber;
   a reservoir in fluid communication with the adjustment volume; and
   an actuator configured to move fluid from the reservoir to the adjustment volume or from the adjustment volume to the reservoir.

Aspect 37. The snowmobile suspension system according to aspect 36, wherein the actuator includes a servo motor or a stepper motor.

Aspect 38. The snowmobile suspension system according to aspect 37, further comprising an actuator control configured to be attached to handlebars of a snowmobile.

Aspect 39. The snowmobile suspension system according to aspect 36, wherein the actuator comprises a threaded rod and a piston configured to be driven by the threaded rod so as to modify a volume within the reservoir.

Aspect 40. The snowmobile suspension system according to any of aspects 36-39, wherein the adjustable shock absorber includes a spring having a pre-tension, and the adjustable segment is disposed outside of a length of the spring along the adjustable shock absorber.

Aspect 41. The snowmobile suspension system according to any of aspects 36-40, wherein the adjustable shock absorber has consistent damping properties over a full range of the effective length of the adjustable shock absorber.

Aspect 42. The snowmobile suspension system according to any of aspects 36-41, wherein the adjustable shock absorber is configured such that a maximum height of the cross shaft above the lower rail assembly can be modified by up to one and one quarter inches.

Aspect 43. The snowmobile suspension system according to any of aspects 36-42, wherein the adjustable shock absorber is configured such that a maximum height of the cross shaft above the lower rail assembly can be modified by up to one half of one inch.

Aspect 44. A snowmobile comprising the snowmobile suspension system according to any of aspects 36-43.

Aspect 45. A snowmobile suspension system, comprising:
a lower rail assembly;
a front torque arm, the front torque arm including:
   a cross shaft; and
   a plurality of links coupled to the cross shaft, each of the plurality of links rotatably coupled to the lower rail assembly; and
an adjustable shock absorber coupled to the cross shaft of the front torque arm and coupled to the lower rail assembly, the adjustable shock absorber comprising:
   a cylinder;
   a shaft, the shaft including a piston head provided within the cylinder;
   an internal piston provided in a first space on a first side of the piston head within the cylinder; and
   a valve assembly configured to control flow of fluid from the first side to a second space on a second side of the piston head within the cylinder, the valve assembly configured to allow flow from the second space to the first space and obstruct flow from the first space to the second space in a first mode, and the valve assembly is configured to allow flow from the first space to the second space in a second mode.

Aspect 46. The snowmobile suspension system according to aspect 45, wherein the valve assembly is a push-pull valve.

Aspect 47. The snowmobile suspension system according to aspect 45 or 46, wherein the valve assembly is further configured to prohibit flow from the second space to the first space in the second mode.

Aspect 48. The snowmobile suspension system according to aspect 45, wherein the valve assembly includes a solenoid check valve.

Aspect 49. The snowmobile suspension system according to aspect 45, wherein the valve assembly includes a dual check cartridge valve.

Aspect 50. The snowmobile suspension system according to any of aspects 45-49, wherein the valve assembly includes an actuator, and further comprising an actuator control configured to be attached to handlebars of a snowmobile.

Aspect 51. The snowmobile suspension system according to any of aspects 45-50, wherein the adjustable shock absorber is configured such that a maximum height of the cross shaft above the lower rail assembly can be modified by up to one and one quarter inches.

Aspect 52. The snowmobile suspension system according to any of aspects 45-51, wherein the adjustable shock absorber is configured such that a maximum height of the cross shaft above the lower rail assembly can be modified by up to one half of one inch.

Aspect 53. A snowmobile comprising the snowmobile suspension system according to any of aspects 45-52.

Aspect 54. An adjustable end cap for a shock absorber, comprising:
an attachment body, said attachment body defining an internal space;
a piston disposed in the internal space, the piston including a shock absorber shaft receptacle configured to receive a shaft of a shock absorber, the piston movable within the internal space such that a distance from the shock absorber shaft receptacle to an opposite end of the attachment body can be modified; and
a fluid control configured to distribute fluid between a first space and a second space so as to control a position of the piston within the internal space.

Aspect 55. The adjustable end cap according to aspect 54, wherein the fluid control includes an accumulator.

Aspect 56. The adjustable end cap according to aspect 54, wherein the fluid control includes a valve assembly, the valve assembly configured to configured to allow flow from the second space to the first space and obstruct flow from the first space to the second space in a first mode, and the valve assembly is configured to allow flow from the first space to the second space in a second mode.

Aspect 57. The adjustable end according to aspect 56, wherein the valve assembly includes a push-pull valve.

Aspect 58. A snowmobile suspension system comprising:
a lower rail assembly;
a front torque arm, the front torque arm including:
   a cross shaft; and
a plurality of links coupled to the cross shaft, each of the plurality of links rotatably coupled to the lower rail assembly;
a shock absorber coupled to the lower rail assembly and the front torque arm, the shock absorber including a shaft, the shock absorber including the adjustable end cap of claim 54, wherein the shaft of the shock absorber is received in the shock absorber shaft receptacle of the adjustable end cap.

Aspect 59. The snowmobile suspension system according to aspect 58, wherein the adjustable end cap is configured such that a maximum height of the cross shaft above the lower rail assembly can be modified by up to one and one quarter inches.

Aspect 60. The snowmobile suspension system according to aspect 58, wherein the adjustable end cap is configured such that a maximum height of the cross shaft above the lower rail assembly can be modified by up to one half of one inch.

Aspect 61. A snowmobile comprising the snowmobile suspension system according to any of aspects 58-60.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A snowmobile comprising:
a suspension system including a lower rail assembly and a front torque arm including a cross shaft and one or more links rotatably attached to the lower rail assembly;
a control interface configured to receive an operating mode and, in response to receiving the operating mode, provide an electronic control signal; and
an actuator configured to receive the electronic control signal and control a maximum height of the cross shaft relative to the lower rail assembly in response to the electronic control signal.

2. The snowmobile of claim 1, wherein the control interface includes a selector provided on a handlebar of the snowmobile.

3. The snowmobile of claim 1, wherein the control interface includes a display showing a user interface.

4. The snowmobile of claim 1, wherein the control interface is configured to receive a user selection of an operating mode, and to provide the electronic control signal in response to the user selection of the operating mode.

5. The snowmobile of claim 1, wherein the control interface includes a controller configured to determine an operating mode and provide the electronic control signal based on the determined operating mode.

6. The snowmobile of claim 5, wherein the controller is configured to determine the operating mode based on one or more of acceleration of the snowmobile, pitch of the snowmobile, power output of an engine of the snowmobile, position of one or more shock absorbers of the snowmobile, input at a brake of the snowmobile, and input at a throttle of the snowmobile.

7. The snowmobile of claim 1, wherein the actuator includes a first fluid space, a second fluid space, and a valve assembly including a check valve, wherein the valve assembly is configured to regulate flow between the first fluid space and the second fluid space, and wherein the valve assembly is configured to respond to the electronic control signal.

8. The snowmobile of claim 7, wherein the check valve is a solenoid check valve.

9. The snowmobile of claim 7, wherein the actuator includes an arm attached to a piston including at least a portion disposed in the first fluid space, the arm coupled to a limiter strap, the limiter strap coupled to one of the lower rail assembly or the cross shaft, wherein adding or removing fluid from the first fluid space moves the piston so as to extend or retract the arm.

10. The snowmobile of claim 7, wherein the first fluid space and the second fluid space are each provided within a cylinder of an adjustable shock absorber coupled to the lower rail assembly and to the cross shaft, wherein the first fluid space and the second fluid space are divided by a piston of the adjustable shock absorber, and wherein an internal piston is disposed within the first fluid space.

11. The snowmobile of claim 1, further comprising a limiter strap coupled to the actuator and the lower rail assembly, wherein the actuator is a limiter strap adjuster configured to extend or retract the limiter strap so as to modify a length of the limiter strap extending from the cross shaft to the lower rail assembly in response to the electronic control signal.

12. The snowmobile of claim 1, further comprising a shock absorber mounting adjustment assembly provided on the cross shaft, the shock absorber mounting assembly including:
one or more cam supports configured to receive a fastener; and
a cam including a cam body defining a shock mounting surface and an aperture configured to receive the fastener such that the cam can rotate about the fastener, wherein a center of the cam body defining the shock mounting surface is offset from a center of the aperture,
wherein the actuator is configured to rotate the cam about the fastener.

13. The snowmobile of claim 1, further comprising an adjustable shock absorber coupled to the cross shaft of the front torque arm and coupled to the lower rail assembly, the adjustable shock absorber comprising:
an adjustable segment disposed at an end of the adjustable shock absorber, the adjustable segment defining an adjustment volume;
a piston configured to travel along the adjustment volume to as to increase or decrease an effective length of the adjustable shock absorber; and
a reservoir in fluid communication with the adjustment volume,
wherein the actuator is configured to move fluid from the reservoir to the adjustment volume or from the adjustment volume to the reservoir.

14. The snowmobile of claim 1, further comprising an adjustable shock absorber coupled to the cross shaft of the front torque arm and coupled to the lower rail assembly, the adjustable shock absorber comprising:
a cylinder;
a shaft, the shaft including a piston head provided within the cylinder; and
an internal piston provided in a first space on a first side of the piston head within the cylinder,
wherein the actuator is a valve assembly configured to control flow of fluid from the first side to a second space on a second side of the piston head within the cylinder, the valve assembly configured to allow flow from the second space to the first space and obstruct flow from the first space to the second space in a first mode, and the valve assembly is configured to allow flow from the first space to the second space in a second mode.

15. A method of controlling snowmobile ride characteristics, comprising:
receiving, at a control interface, an operating mode for a snowmobile;
transmitting an electronic control signal from the control interface to an actuator in response to receiving the operating mode;
receiving, at an actuator, the electronic control signal; and
operating the actuator in response to the electronic control signal, wherein operating the actuator changes a maximum height of a cross shaft of a front torque arm of a suspension system above a lower rail assembly of the suspension system.

16. The method of claim 15, further comprising receiving a user input of the operating mode at the control interface.

17. The method of claim 15, further comprising determining the operating mode for the snowmobile based on one or more of acceleration of the snowmobile, pitch of the snowmobile, power output of an engine of the snowmobile, position of one or more shock absorbers of the snowmobile, input at a brake of the snowmobile, and input at a throttle of the snowmobile.

18. The method of claim 15, wherein the actuator is a hydraulic actuator.

19. The method of claim 18, wherein operating the actuator extends or retracts a limiter strap coupled to the actuator and one of the cross shaft or the lower rail assembly.

20. The method of claim 18, wherein operating the actuator changes a length of an adjustable shock absorber coupled to the cross shaft and the lower rail assembly.
